(19) United States
(12) Patent Application Publication
(10) Pub. No.: US 2026/0161933 A1
(43) Pub. Date: Jun. 11, 2026

(54) CAUSAL PREDICTIVE OPTIMIZATION FOR CONNECTION NETWORK SERVICES

(71) Applicant: Microsoft Technology Licensing, LLC, Redmond, WA (US)

(72) Inventors: Changshuai Wei, Lynnwood, WA (US); Himadeep Reddy Reddivari, Lynnwood, WA (US); Olurotimi Nugbepo Seton, St. Thomas (CA); Liyang Zhao, Jersey City, NJ (US); Sameer Somnath Matale, Sunnyvale, CA (US)

(73) Assignee: Microsoft Technology Licensing, LLC, Redmond, WA (US)

(21) Appl. No.: 18/975,605

(22) Filed: Dec. 10, 2024

(51) Int. Cl. G06N 3/0475; G06Q 50/00

(52) U.S. Cl. CPC G06N 3/0475; G06Q 10/40

(57) ABSTRACT

Artificial intelligence (AI) techniques for connection networking are described. A method comprises receiving an input vector comprising a first vector and a second vector by a causal model of a prediction layer of a connection network system, generating an output vector comprising a metric by the causal model based on the first vector and the second vector, the metric comprising a value representing an objective for a set of entity identifiers, generating a set of scores for the set of entity identifiers using an objective function of an optimization layer, selecting an entity identifier from the set of entity identifiers based on the set of scores, generating a recommendation for the entity identifier, and routing the recommendation to a target application of an electronic device. Other embodiments are described and claimed.

### BACKGROUND

The proliferation of online networks, such as social platforms, has enabled the creation of user profiles and publicly visible content while driving increased communication through these ecosystems. Interactions within such networks, along with their timing and order, can be modeled as “interaction sequences.” These sequences, which represent ordered lists of user or content-level interactions, provide a basis for analyzing user behavior. At the user level, sequences track individual interactions and their temporal patterns, while at the content level, they capture engagement from multiple users with specific content over time.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a connection network system in accordance with one embodiment.

FIG. 2 illustrates a system in accordance with one embodiment.

FIG. 3 illustrates a content delivery system in accordance with one embodiment.

FIG. 4 illustrates a machine learning (ML) architecture in accordance with one embodiment.

FIG. 5 illustrates a logic diagram in accordance with one embodiment.

FIG. 6 illustrates a logic diagram in accordance with one embodiment.

FIG. 7 illustrates a logic diagram in accordance with one embodiment.

FIG. 8 illustrates a transformer model in accordance with one embodiment.

FIG. 9 illustrates a graphical user interface (GUI) in accordance with one embodiment.

FIG. 10 illustrates a logic flow in accordance with one embodiment.

FIG. 11 illustrates a logic flow in accordance with one embodiment.

FIG. 12 illustrates an apparatus in accordance with one embodiment.

FIG. 13 illustrates a logic diagram in accordance with one embodiment.

FIG. 14 illustrates an artificial neural network (ANN) in accordance with one embodiment.

FIG. 15 illustrates a computer-readable storage medium in accordance with one embodiment.

FIG. 16 illustrates a computing architecture in accordance with one embodiment.

FIG. 17 illustrates a communications architecture in accordance with one embodiment.

### DETAILED DESCRIPTION

Embodiments are generally directed to a connection network system. Some embodiments are particularly directed to artificial intelligence (AI) and machine learning (ML) techniques to support applications and/or services provided by a connection network system. Although exemplary embodiments are described in connection with a particular AI system or an ML model, the principles described herein can also be applied to other types of AI systems and ML models as well. Embodiments are not limited in this context.

### Overview

A connection network system may provide access to a large amount of electronic content aimed at professional networking and career development. For example, a connection network system may list employment opportunities posted by employers across different industries, professional profiles with detailed information about users of the connection network system (e.g., work experience, skills, and endorsements), articles or posts created by users and industry leaders covering various topics (e.g., business, technology, and career advice), online courses and tutorials on a wide range of professional skills and subjects, company profiles offering insights about a company (e.g., company culture, job openings, and industry news), connections and networking tools to connect with and recommend other professionals, forums and discussion groups where users can share ideas and discuss industry trends, and other types of content designed to facilitate professional growth and industry engagement.

Various types of entities may generate, modify, store, read, or otherwise interact with the electronic content of the connection network system. Non-limiting examples of an entities include an individual, a person, a user, a member, a subscriber, a corporate entity, a company, a business, an organization, a governmental agency, a community, a group, and the like. In some cases, the connection network system collects a variety of data associated with the various types of entities of the platform in accordance with privacy policies which govern how this information is collected, used, and shared. For an entity such as a user, the entity data may include basic profile information such as name, job title, industry, location, educational background, demographic information, work history, and so forth. For an entity such as a company, the entity data may also include basic profile information such as a company name, description, industry, business segment, jobs, careers, offices, geographic locations, and so forth. Additionally, the connection network system may collect activity data for entities representing various interactions and behaviors exhibited while on the platform. Examples of activity data including interactions between entities or interacting with electronic content of the connection network system, including profile updates, content engagement, search and navigation behavior, job activities, networking activities, group participation, skill endorsements and recommendations, advertisement engagement, learning activities, event participation, followers activities, interactions with external content, engagement patterns, behavioral trends, organic updates, sponsored updates, sales activities, marketing activities, and so forth.

Given this plethora of rich entity data and activity data, a connection network system may use this data to create and enhance network services offered to various entities by the connection network system. For instance, the connection network system may implement a given network service using a server-based application via a software-as-a-service (SaaS) model. Non-limiting examples of network services include relationship services, sales services, customer management services, lead generation services, talent management services, recruiting services, job posting services, search services, ranking services, recommendation services, advertising services, content delivery services, and other types of network services. For example, a connection network system may use activity data to personalize user experiences, optimize content displayed in feeds, improve targeted advertising, increase sales revenue, provide recommendations, and enhance platform features. It also plays a role in developing analytics and reporting tools, helping users and businesses understand their network reach, content effectiveness, and engagement with their audience.

In particular, a connection network system may offer an insight service to generate and provide insights, such as recommendations, for various entities of the connection network system based on entity data and activity data. For example, an insight manager application may analyze entity data and activity data of various entities of the connection network system, and it may generate recommendations based on the analysis. For example, the insight manager may surface connections you may be interested in (CYMBII) to an entity to establish new connections, jobs you may be interested in (JYMBII) to an entity to assist in a job search, marketing and sales leads to an entity to assist in marketing and selling products or services to other entities, recruiting candidates to an entity to fill an open job position, and other types of insights.

To generate an insight, the connection network system may analyze sequences of past events associated with an entity (e.g., interactions between an entity and a network service or a content item) in order to predict a next action by the entity or for the entity. In some cases, the past events may be an ordered list of interactions (although not required) with metadata such as timing information or location information. For example, an entity may perform a sequence of past events that include performing a job search and viewing a job opening. The connection network system may analyze the sequence of past events to predict a next action by the entity, such as applying for the job opening, or a next action for the entity, such as recommending a new job opening. In some cases, the next action is used for a recommendation for one entity to perform an action for another entity. For example, the next action may be for an account representative of a company to contact a current or prospective customer in order to increase revenue from the customer. Sometimes the next action is referred to as a “next best action,” although the term “best” does not necessarily denote an optimal action but rather a recommended action that fits some defined criteria or objectives.

In some cases, the insight manager may provide insights directly to an entity of a connection network system to use a given network service. In other cases, the insight manager may provide insights indirectly to the entity via another network service of the connection network system. For example, the insight manager may provide insights to a connection intelligence service that provides relationship services, sales services, recruiting services, talent manager services, and so forth. A connection intelligence service provides a suite of tools and services designed to provide intelligence to entities of the connection network system (e.g., companies) to discover connections and resources that can assist in the business entity in meeting a set of objectives. For example, an objective may be defined as growth of certain business accounts to increase revenue from products and services (e.g., lifecycle revenue), focus limited resources (e.g., people, time, money, energy, etc.) on potential business opportunities, and identify and engage with entities (e.g., buyers) who are ready to purchase or renew entity products and services. For example, a connection intelligence service may highlight potential connections at an account, discover mutual connections to leverage warm introductions, find hidden allies such as old colleagues and influential connections to unlock and grow business counts, prioritize specific accounts to produce better results, focus on top accounts that yield better opportunities, generate key signals to help identify and engage qualified buyers, recommend actions to take a critical stages of the sales process, and personalize outreach to keep leads engaged. By leveraging these solutions, organizations gain access to a vast pool of professionals and benefit from streamlined business processes integrated within a single platform. These services enable data-driven decision-making, improve collaboration among business teams, and enhance company branding to attract the right buyers effectively. Overall, connection intelligence services empower organizations to optimize their branding, marketing and sales strategies in a competitive market.

Conventional solutions suffer from a number of technical deficiencies. For example, a company may employ a number of account representatives to manage one or more business accounts with an intent or objective to increase sales revenue or engagement. Each account representative may manage a large number of business accounts on a daily basis using a number of disparate systems, such as account dashboards, book building tools, prioritization applications, lead generation systems, customer relationship management (CRM) systems, contact management systems, pricing systems, customer feedback systems, and so forth. An account representative typically manages this high account load using a manual prioritization process to gather customer data in an attempt to discover which accounts need some form of action, such as a phone call or message. Once the customer data is collected, the account representative typically performs manual tasks such as perform data analysis, conduct value-based conversations, share prepared content, and tailor strategies to ensure customer success and revenue growth. Given the large number of accounts, different data sources, and sheer volume of customer data, it becomes difficult for an account representative to identify an account that is ready for some form of action (e.g., engagement), prioritize a next best action to take for the identified account (e.g., send a message with a promotion), and when such action should be taken (e.g., every 2 weeks). A tedious and time consuming amount of manual effort is needed to navigate the different systems and find actionable data in order to prioritize their outreach efforts. In addition, a high level of manual effort is needed to customize content based on a given objective for each customer, such as increasing lifetime customer revenue or engagement. In many cases, workflows are ad hoc and lack a consistent approach or strategy to determine what actions to take in order to maximize value for each customer. Therefore, there is a substantial need for improved automated systems to assist an account representative to aggressively prioritize their time, effort and company resources to efficiently and effectively meet customer-oriented objectives.

To overcome these and other challenges, various embodiments implement AI and ML techniques to support various network services for a connection network system. Some embodiments are generally directed to a novel AI architecture and framework that implements one or more ML models trained and deployed to perform inferencing operations in support of a network service. For example, an ML model may be implemented as an artificial neural network (ANN) such as a deep learning ML model trained for different use cases and objectives. In various embodiments, the ML models are specifically designed to support one or more network services provided by the connection network system.

Leveraging historical interaction sequences enables AI and ML models to generate actionable recommendations tailored to user contexts. For instance, in a career-oriented platform, a user viewing a job listing might naturally consider applying but may overlook other valuable actions, such as enrolling in skill-building courses, subscribing to industry updates, or networking with peers. Advanced sequence modeling techniques, such as recurrent neural networks (RNNs) or transformer architectures, can predict user intent and provide personalized, context-aware suggestions, enhancing user engagement and optimizing platform functionality. In another example, in a connection-oriented platform, a user (e.g., an account representative, sales agent, marketing manager, etc.) viewing a list of customers or prospective customers to sell products or services may manually review and analyze the list of customers to determine which customer to contact to increase revenue. However, the user may easily miss a customer or action given a long list combined with multiple data sources and conflicting data. AI and ML techniques can use historical interaction sequences to provide better network services to user or members of a connection network system.

In some embodiments, for example, an insight manager application may provide an insight service to generate insights for a connection intelligence application providing a connection intelligence service to entities of the connection network system. In some embodiments, for example, both the insight service and the connection intelligence service are integrated into a single monolithic network service of the connection network system. Embodiments are not limited in this context.

In some embodiments, for example, the insight manager may generate insights or recommendations for a producing entity to sell products or services to a target entity. One or both of the producing entity and the target entity may be members (e.g., users or subscribers) of the connection network system. As such, the connection network system stores entity data and activity data for one or both entities. The insight manager may use this data to generate, at least in part, insights for the connection intelligence application. In some embodiments, the producing entity is a business entity (e.g., a company) and the target entity is a consumer entity (e.g., a user) in a business-to-consumer (B2C) model. In some embodiments, the producing entity is a business entity and the target entity is another business entity in a business-to-business (B2B) model.

The insight manager may use an ML model, such as a single or multi-layer prediction model, to generate a set of candidate target entities, an optimization algorithm implementing an objective function to optimize the set of candidate target entities (e.g., identify a subset), select a target entity ready for an action (e.g., a next action or next best action) from the set of candidate target entities (e.g., filter or rank the subset), and a recommendation model to generate a recommendation for a producing entity about the target entity. The recommendation may be generated in a human-readable form, such as in a natural human language.

In accordance with various embodiments, a connection network system may implement an insight manager application and a connection intelligence application to address the technical challenges associated with conventional systems. The insight manager application may be implemented using a flexible and modular computing architecture or framework that includes one or more ML models, such as a prediction model, a ranking model, and a recommendation model. Further, an optimization algorithm may implement an objective function (e.g., using mixed-integer programming) to further refine the output of the prediction model. The insight manager application may assist the connection intelligence application in identifying a target entity from a set of candidate target entities (e.g., individuals, users, members, subscribers, companies, groups, organizations, agencies, etc.), represented via a set of entity identifiers associated with the candidate target entities, that are suitable for engagement by, or interaction with, a producing entity. The connection intelligence application may also provide a recommendation for the producing entity regarding the target entity, such as an action to take for the target entity, when to take such action, customized content for the target entity, statistical metrics associated with the target entity, and other types of data associated with the target entity and relevant in a decision-making process for the producing entity.

The connection intelligence application, with the assistance of the insight manager application, is generally designed to identify, generate and deliver electronic recommendations to entities (e.g., customers of the connection network system) based, at least in part, on entity data and activity data of various entities of the connection network system. In particular, the connection intelligence application may utilize one or more ML models to deliver recommendations to a producing entity (e.g., an account representative, sales agent, marketing manager, etc.) to perform an action for a target entity (e.g., a customer, a business, a user, etc.) to further a defined objective associated with the target entity. Non-limiting examples of actions may include engagement such as an entity to contact (e.g., an upsell/churn action at a renewal time for a contract from a monetization perspective), topics to discuss, promotional offers to provide, and otherwise prompting an engagement (e.g., an interaction or “touchpoint”) between the producing entity and the target entity. Non-limiting examples of engagement include conducting a phone call, sending a message, delivering a content item like an advertisement, providing a sales promotion, and so forth. Non-limiting examples of objectives may include optimizing potential revenue from an entity, increasing customer engagement, selling a particular product or service, initiating or renewing a subscription, maximizing short term engagement, maximizing long term engagement, maximizing a likelihood of specific actions being undertaken at some point (e.g., short term, medium term, long term, and so forth), and so forth. The insight manager application and connection intelligence application are designed to interoperate in order to identify a given account for a specific action at a defined time. Utilizing machine learning, the insight manager application and the connection intelligence application can streamline and eliminate the need for manual categorization of customers and the identification of accounts experiencing declining engagement. These approaches empower account representatives to navigate the technical complexities of the sales process effectively, leading to successful client acquisitions and satisfaction.

In some embodiments, the insight manager application and/or connection intelligence application may implement some or all of an ML architecture or framework that includes, among other elements, a prediction layer, an optimization layer, and an explainability layer. The prediction layer is generally designed to predict metrics representing certain objectives (e.g., business objectives) associated with entities, such as monetization potential or customer engagement, for example. The prediction layer may implement a ML model such as a causal model (e.g., a doubly-robust estimator) to estimate an incremental value from sales engagement on one or more objectives, such as monetization effort and engagement, for example. A ranking model (or ranking algorithm) may use the metrics to rank entity identifiers using a first ranking algorithm, which are then output to an optimization layer. The optimization layer is generally designed to implement an objective function to optimize the metrics for the ranked entities. The optimization layer may also use a set of rules, including hard rules and soft rules, as constraints for the objective function. The objective function outputs a set of scores for the entity identifiers. The ranking model may use the scores to rank (or re-rank) the entity identifiers using a second ranking algorithm. Once the entity identifiers are ranked, the optimization layer provides supporting information including whether each entity identifier is associated with an account that should be recommended due to the objectives (e.g., monetization or engagement estimates). A recommendation model (or recommendation algorithm) may then generate one or more recommendations for one or more entity identifiers associated with accounts that need action to further the objectives. The recommendation model may generate the recommendations using a defined template (e.g., for a customer, product, service, action, touchpoint, etc.), a generative artificial intelligence (GAI) model (e.g., a large language model), or a combination of both. Finally, the explainability layer enhances a trust and/or confidence value to the connection intelligence by providing natural language expressions (e.g., human-readable explanations) for the recommendations it generates. It takes the features and output from the prediction layer and/or optimization layer and it generates explanations or comments via templates and/or the GAI, such as global feature importance, instance level feature importance, and/or a time series summary.

It can be appreciated that embodiments are not limited to certain network services such as insight services or connection intelligence services, and can be implemented for any network services provided by a connection network system, such as a talent management service, among other types of network services. Embodiments are not limited in this context. In other embodiments, the insight manager application and supporting ML models are designed to support other network services provided by a connection network system. Non-limiting examples of network services include relationship services, sales services, customer management services, lead generation services, talent management services, recruiting services, job posting services, search services, ranking services, recommendation services, advertising services, content delivery services, and other types of network services. Embodiments are not limited in this context.

The embodiments disclosed herein provide several technical solutions to technical problems faced by conventional systems. For example, embodiments provide automation that enables a connection intelligence to generate predictive alerts for customers at optimal moments. It also ensures that customers with impending renewals are well served. On a periodic basis (e.g., daily, weekly, monthly, etc.), the connection intelligence will identify entity accounts in need of outreach as well as recommend entity accounts identified as potential churn risks or growth opportunities. For example, the connection intelligence will flag certain accounts as risk accounts, regardless of their renewal status within a given time period (e.g., the next 90 days), particularly if they exhibit low engagement and adoption signals that may indicate potential future churn. Additionally, the connection intelligence will flag growth accounts based on their near-term growth potential or their current healthy account status and increasing engagement with products or services offered by the connection intelligence. For each recommended account, the recommendation will provide a concise explanation of the rationale behind notification. By automating these aspects of business processes, account representatives can redirect their efforts towards crafting tailored content and renewal strategies for strategic clients, rather than spending resources on analyzing account portfolios to determine where to begin and concentrate their efforts. Further, embodiments reduces efforts needed for prioritization by recommending accounts that need attention, simplifies work flows by surfacing insights and information that drives the prioritization recommendation, and increases productivity by recommending actions in addition prioritization. In addition, embodiments introduce a level of personalization with recommendations and insights customized for a given entity or contact preference. Embodiments provided other technical solutions to other technical problems as well.

The embodiments disclosed herein are only examples, and the scope of this disclosure is not limited to them. Particular embodiments may include all, some, or none of the components, elements, features, functions, operations, or steps of the embodiments disclosed above. Embodiments according to the invention are in particular disclosed in the attached claims directed to a method, a storage medium, a system and a computer program product, wherein any feature mentioned in one claim category, e.g. method, can be claimed in another claim category, e.g. system, as well. The dependencies or references back in the attached claims are chosen for formal reasons only. However any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### Detailed Embodiments

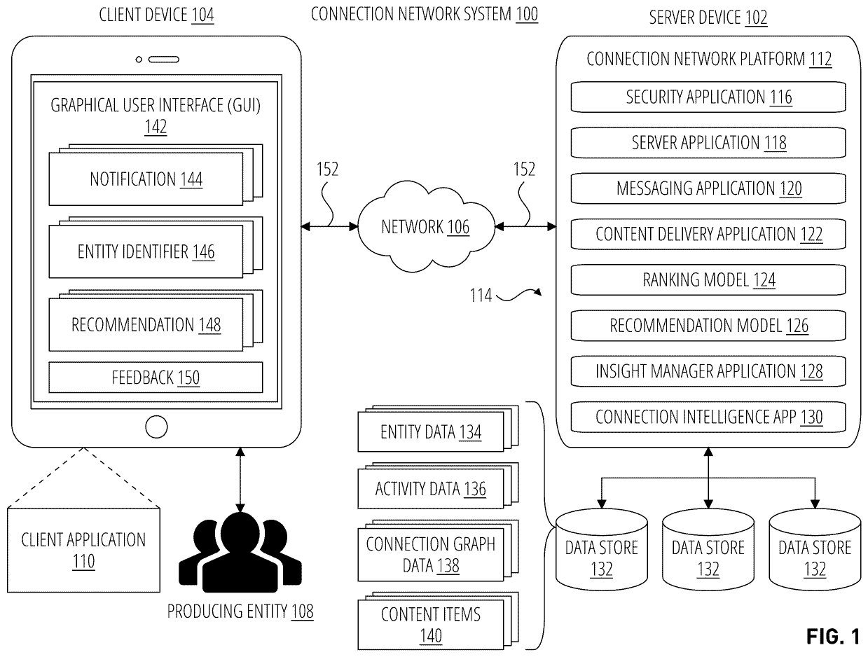

FIG. 1 illustrates a connection network system 100. The connection network system 100 is an example of an architecture or framework for an online computer and communications system designed to serve content items to an electronic device associated with a user. Embodiments are not limited to this example.

In general, the connection network system 100 may include a variety of servers, sub-systems, programs, modules, logs, and data stores. In particular embodiments, the connection network system 100 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. The connection network system 100 may also include suitable components such as network interfaces, security mechanisms, load balancers, failover servers, management-and-network-operations consoles, privacy software, and other suitable components, or any suitable combination thereof.

As depicted in FIG. 1, the connection network system 100 comprises a server device 102 communicating with a client device 104 over a network 106. In operation, a producing entity 108 interacts with a client application 110 of the client device 104 to access applications and services provided by a connection network platform 112 of the server device 102. The connection network platform 112 offers a number of network services 114 for the connection network system 100, such as network services provided by a security application 116, a server application 118, a messaging application 120, a content delivery application 122, a ranking model 124, and/or a recommendation model 126. The server device 102 has access to one or more data stores 132. The data stores 132 store information for the connection network platform 112, such as entity data 134, activity data 136, connection graph data 138, and content items 140.

The connection network system 100 comprises a server device 102. In particular embodiments, a server device 102 may be an electronic device including hardware, software, or embedded logic components or a combination of two or more such components and capable of carrying out the appropriate functionalities implemented or supported by a server device 102. The server device 102 may comprise a unitary server or a distributed server spanning multiple computers or multiple data centers. The server device 102 may comprise one or more physical servers or virtual servers hosting one or more networking applications. As an example and not by way of limitation, a server device 102 may comprise part of a larger server system comprising multiple server devices organized as a data center, an edge computing center, or a cloud-computing center. This disclosure contemplates any suitable server device 102. A server device 102 may be accessed by a network producing entity 108 at a client device 104 via the network 106. A client device 104 may enable its producing entity 108 to communicate with other producing entities 108 at the server device 102, such as via messaging applications 120.

In one embodiment, for example, the server device 102 may be implemented as a web server. The web server may be used for linking the connection network platform 112 to one or more of the client devices 104 via a network 106. The web server may include a mail server or other messaging functionality for receiving and routing messages between the connection network platform 112 and one or more client devices 104. An API-request server may allow a gaming platform, a third-party system, a messaging system, and/or an AI system to access information from the connection network platform 112 by calling one or more APIs. An action logger may be used to receive communications from a web server about a user's actions on or off the connection network platform 112. In conjunction with the action log, a third-party-content-object log may be maintained of user exposures to third-party-content objects. A notification controller may provide information regarding content objects to a client device 104. Information may be pushed to a client device 104 as notifications, or information may be pulled from a client device 104 responsive to a request received from a client device 104. Authorization servers may be used to enforce one or more privacy settings of the users of the connections networking system. A privacy setting of a user determines how particular information associated with a user can be shared. The authorization server may allow users to opt in to or opt out of having their actions logged by the connection network platform 112 or shared with other systems (e.g., a third-party system), such as, for example, by setting appropriate privacy settings. Third-party-content-object stores may be used to store content objects received from third parties, such as a third-party system. Location stores may be used for storing location information received from client device 104 associated with users. Advertisement-pricing modules may combine connections information, the current time, location information, or other suitable information to provide relevant advertisements, in the form of notifications, to a user.

The connection network system 100 comprises a connection network platform 112. In particular embodiments, the connection network platform 112 may be part of a network-addressable computing system that can host an online connection network. The connection network platform 112 may generate, store, receive, and send connection networking data, such as, for example, entity data 134 (e.g., user-profile data, concept-profile data, etc.), activity data 136 (e.g., user interactions with connection network platform 112), connection graph data 138 (e.g., connections between users or entities), content items 140, or other suitable data related to the online connection network. The connection network platform 112 may be accessed by the other components of the connection network system 100 either directly or via a network 106. As an example and not by way of limitation, a client device 104 may access the connection network platform 112 using the client application 110, which may be a web browser or a native application associated with the connection network platform 112 (e.g., a mobile connection network application, another suitable application, or any combination thereof) either directly or via a network 106.

The connection network platform 112 may offer, provide or implement a number of network services 114 via one or more applications (e.g., SaaS model), such as a security application 116, server application 118, messaging application 120, content delivery application 122, ranking model 124, recommendation model 126, insight manager application 128, and/or connection intelligence application 130. Embodiments are not limited to these examples.

The connection network platform 112 comprises a security application 116. In particular embodiments, a security application 116 may be an application or electronic device including hardware, software, or embedded logic components or a combination of two or more such components and capable of carrying out the appropriate functionalities implemented or supported by the security application 116. The security application 116 is a network security system that encompasses a suite of technologies, policies, and practices designed to protect the integrity, confidentiality, and availability of data within the connection network platform 112 from unauthorized access, attacks, and other security threats. The security application 116 comprises components such as firewalls, which act as a barrier between trusted and untrusted networks; Intrusion Detection and Prevention Systems (IDPS) that monitor for malicious activity; antivirus and anti-malware software for removing harmful software; and Virtual Private Networks (VPNs) for secure remote access. Additionally, Data Loss Prevention (DLP), email security measures, and encryption are vital for protecting sensitive information and ensuring that only authorized users can access and understand it. Effective network security also requires rigorous access control to restrict network resources to authorized users, alongside Security Information and Event Management (SIEM) systems for real-time security alert analysis. Endpoint security further safeguards devices connected to the network, which are frequent entry points for security threats. The security application 116 implements security practices to ensure a robust defense against a wide array of cyber threats, safeguarding organizational assets and maintaining trust with stakeholders.

The connection network platform 112 comprises a server application 118. In particular embodiments, the server application 118 may be a web server to serve content information, such as content items 140, to the client application 110 of the client device 104. The server device 102 may accept an HTTP request and communicate to a client device 104 one or more HTML files responsive to the HTTP request. The server device 102 may send HTML files representing a webpage with content information for presentation via an electronic display of the client device 104 to the producing entity 108.

In particular embodiments, the server application 118 may be an application operable to provide various computing functionalities, services, and/or resources, and to send data to and receive data from the other entities of the network 106, such as the client device 104, the connection network platform 112, a third-party server, and other electronic devices within the connection network system 100. For example, the server application 118 may be an e-commerce application, a content application, an advertisement application, a web interface, a messaging application, a video application, a webpage, and so forth.

In particular embodiments, the server application 118 may be an application for managing various applications and services provided by the online connection network hosted on the connection network platform 112. In particular embodiments, the server application 118 may include hardware, software, or embedded logic components or a combination of two or more such components for carrying out the appropriate functionalities implemented or supported by connection network platform 112. Although the server device 102 is shown with a single server application 118, it should be noted that this is not by any way limiting and this disclosure contemplates any number of server applications 118.

The connection network platform 112 comprises a messaging application 120. The messaging application 120 is software that enables users to send and receive messages, including text, images, videos, and other multimedia content, over a network 106, such as a local or broad network such as the internet. These applications support real-time communication, allowing immediate message exchange, and typically offer features like group messaging, notifications, and file sharing. They manage user identities, contacts, and groups, while ensuring security through authentication and encryption measures. Designed to operate over various network types, such as Wi-Fi or cellular data, messaging applications can also integrate with other network services and platforms, enhancing their functionality and user experience.

The connection network platform 112 comprises a content delivery application 122. The content delivery application 122 is a software tool that allows users to efficiently deliver content items to other users of the connection network platform 112 of the connection network system 100, such as content items 140 stored by one or more data stores 132 or third-party content servers. An example for the content delivery application 122 is a demand-side platform (DSP) used by users such as employees (e.g., an account manager) for an advertising entity. A DSP allows advertisers to purchase and manage ad inventory from multiple ad exchanges and networks through a single interface to implement marketing solutions for products or services of the advertiser. The content delivery application 122 allows advertisers to create, manage, and analyze their ad campaigns on the platform in accordance with a larger programmatic advertising strategy. It allows for precise targeting based on entity data 134 and/or activity data 136, making it especially useful for business-to-business (B2B) or business-to-consumer (B2C) marketing campaigns. The content delivery application 122 delivers content items 140, such as a series of one or more advertisements, to an audience of producing entities 108 of the connection network platform 112 of the connection network system 100. The content delivery application 122 assist advertisers in delivering content and ads to a professional audience by leveraging user profiles, job titles, industries, and other entity data 134 and activity data 136 collected by the connection network platform 112.

The connection network platform 112 comprises various machine learning (ML) models, such as a ranking model 124. A ranking model 124 in machine learning is a ML model designed to order or prioritize a set of items based on their relevance to a given query. Unlike traditional classification or regression models, ranking models output a sorted list of items, making them essential for applications like information retrieval systems, recommendation engines, and search engines. They predict the relevance of each item, employing specialized loss functions and feature engineering to optimize ranking order. Performance is evaluated using metrics such as Mean Reciprocal Rank (MRR) and Normalized Discounted Cumulative Gain (NDCG). Examples include RankNet, LambdaRank, and LambdaMART, which are used by the connection network platform 112 to surface the most relevant results or recommendations to users.

The connection network platform 112 comprises various ML models, such as a recommendation model 126. A recommendation model 126 in machine learning is an ML model designed to predict and suggest items that are likely to be of interest to users, analyzing patterns in user behavior, preferences, and interactions to generate personalized recommendations. These models are widely used in e-commerce, streaming services, and social media to enhance user experience and engagement. Techniques include collaborative filtering, which identifies similarities between users and items based on interactions and feedback, and content-based filtering, which recommends items similar to those a user has shown interest in based on item attributes. Hybrid methods combine multiple approaches to improve accuracy and diversity. Evaluation metrics for recommendation models include precision, recall, Mean Average Precision (MAP), and Normalized Discounted Cumulative Gain (NDCG). Examples include matrix factorization techniques, deep learning approaches like neural collaborative filtering, and graph-based methods, as utilized by platforms such as YouTube, Spotify, and Amazon to provide tailored content and product suggestions.

The connection network platform 112 comprises an insight manager application 128. The insight manager application 128 may generate insights (e.g., recommendations 148) for the client application 110. Additionally, or alternatively, the insight manager application 128 may generate recommendation 148 for another network service offered by the connection network platform 112. For example, the insight manager application 128 may interoperate with the connection intelligence application 130 to generate insights for the connection intelligence application 130 of the connection network system 100. In some embodiments, both the insight manager application 128 and the connection intelligence application 130 may be integrated into a single network application offering a single network service.

The insight manager application 128 may generate insights for a producing entity 108 to sell products or services to a target entity. In some embodiments, the producing entity 108 and the target entity are both members (e.g., users or subscribers) of the connection network system 100. As such, the connection network system 100 stores entity data 134 and activity data 136 for both entities. The insight manager application 128 may use this data, at least in part, to generate the insights for the connection intelligence application 130. In some embodiments, the producing entity 108 is a business entity (e.g., a company) and the target entity is a consumer entity (e.g., a user) in a business-to-consumer (B2C) model. In some embodiments, the producing entity 108 is a business entity and the target entity is another business entity in a business-to-business (B2B) model. The insight manager application 128 may use, at least in part, a single or multi-layer prediction model to generate a set of candidate target entities, an optimization algorithm implementing an objective function to optimize the set of candidate target entities (e.g., filter or identify a subset) and select a target entity ready for an action from the set of candidate target entities, and a recommendation model to generate a recommendation 148 for the producing entity 108. The recommendation 148 may be generated in a human-readable form, such as in a natural language. Embodiments are not limited to certain network services such as insight services or connection intelligence services, and can be implemented for any network services provided by a connection network system 100, such as a talent management service, among other types of network services. Embodiments are not limited in this context.

The connection network platform 112 comprises a connection intelligence application 130. With the assistance of the insight manager application 128, the connection intelligence application 130 is generally designed to identify, generate and deliver electronic recommendations 148 to the producing entity 108 (e.g., customers) about a target entity based, at least in part, on entity data 134 and activity data 136 of one or more target entities of the connection network system 100. In particular, the connection intelligence application 130 may utilize one or more ML models to deliver recommendations to the producing entity 108 (e.g., an account representative, sales agent, marketing manager, etc.) to perform an action for a target entity (e.g., a customer, a business, a user, etc.) to further a defined objective associated with the target entity. Non-limiting examples of actions may include engagement such as an entity to contact, topics to discuss, offers to provide, and otherwise prompting an interaction between the producing entity and the target entity, such as conducting a phone call, sending a message, delivering a content item like an advertisement, providing a promotion, and so forth. Non-limiting examples of objectives may include optimizing potential revenue from an entity, increasing customer engagement, selling a particular product or service, initiating or renewing a subscription, and so forth. The insight manager and connection intelligence are designed to interoperate in order to identify a given account for a specific action at a defined time. Utilizing machine learning, the connection intelligence can streamline and eliminate the need for manual categorization of customers and the identification of accounts experiencing declining engagement. These approaches empower account representatives to navigate the technical complexities of the sales process effectively, leading to successful client acquisitions and satisfaction.

The server device 102 comprises, or has access to, one or more data stores 132. In particular embodiments, the connections networking system 102 may include a data store 132. The data store 132 may be used to store various types of information for the server device 102 and/or the connection network platform 112. In particular embodiments, the information stored in the data store 132 may be organized according to specific data structures. In particular embodiments, the data store 132 may be a relational, columnar, correlation, or other suitable database. Although this disclosure describes or illustrates particular types of databases, this disclosure contemplates any suitable types of databases. Particular embodiments may provide interfaces that enable a client device 104 or a connection network system 100 to manage, retrieve, modify, add, or delete, the information stored in the data store 132.

In one embodiment, for example, the data store 132 stores entity data 134 for the connection network platform 112. In particular embodiments, the connection network platform 112 may include entity data 134 for users of the connection network platform 112. For example, the entity data 134 may comprise one or more user profiles. A user profile may include, for example, biographic information, demographic information, behavioral information, social information, professional information, or other types of descriptive information, such as work experience, educational history, hobbies or preferences, interests, affinities, or location. Interest information may include interests related to one or more categories. Categories may be general or specific. The connection information may indicate users who have similar or common work experience, group memberships, hobbies, educational history, or are in any way related or share common attributes. The connection information may also include user-defined connections between different users and content (both internal and external).

In one embodiment, for example, the data store 132 stores activity data 136 for the connection network platform 112. The activity data 136 represents various activities recorded for a producing entity 108 by the connection network platform 112. In particular embodiments, the connection network platform 112 may provide users with the ability to take actions on various types of items or objects supported (or accessible) by connection network platform 112. As an example and not by way of limitation, the items and objects may include groups or connections networks to which users of the connection network platform 112 may belong, events or calendar entries in which a user might be interested, computer-based applications that a user may use, transactions that allow users to apply to job openings or post job openings via the service, interactions with advertisements that a user may perform, content items, online games, or other suitable items or objects. A user may interact with anything that is capable of being represented in the connection network platform 112 or by an external system of a third-party system, which is separate from the server device 102 and coupled to the server device 102 via a network 106.

In one embodiment, for example, the data store 132 stores connection graph data 138 for the connection network platform 112. The connection network platform 112 may store connection graph data 138 for one or more users (e.g., members with subscription accounts) of the connection network platform 112. In one embodiment, for example, connection graph data 138 may be connection data for users organized as a graph. The graph may include multiple nodes, which may include multiple user nodes each corresponding to a particular user or multiple entity nodes each corresponding to a particular entity, such as a business entity. The graph may also have multiple edges connecting the nodes. The connection network platform 112 may provide users of the online connection network system 100 the ability to communicate and interact with other users. In particular embodiments, users may join the online connection network platform 112 via the connection network system 100 and then add connections (e.g., relationships) to a number of other users of the connection network platform 112 to whom they want to be connected. Herein, the term “connection” may refer to any other user of the connection network platform 112 or the connection network system 100 with whom a user has formed a friendship, association, or relationship via the connection network platform 112.

In one embodiment, for example, the data store 132 stores content items 140 for the connection network platform 112. The content items 140 may comprise any type of multimedia content, such as text files, multimedia files, image files, video files, graphic files, movies, articles, user feeds, advertisements for a content delivery campaign, banners, recommendations, games, messages, emojis, program code, animations, and so forth. In particular embodiments, the connection network platform 112 also includes user-generated content (UGC) objects, which may enhance a user's interactions with the connection network platform 112. User-generated content may include anything a user can add, upload, send, message, or “post” to the connection network platform 112. As an example and not by way of limitation, a user communicates posts to the connection network platform 112 from a client device 104. Posts may include data such as status updates or other textual data, articles, job openings, company information, awards, location information, photos, videos, links, music or other similar data or media. Content may also be added to the connection network platform 112 by a third-party through a “communication channel,” such as a newsfeed or content stream.

The connection network system 100 comprises a client device 104. In particular embodiments, a client device 104 may be an electronic device including hardware, software, or embedded logic components or a combination of two or more such components and capable of carrying out the appropriate functionalities implemented or supported by a client device 104. As an example and not by way of limitation, a client device 104 may include a computer system such as a desktop computer, notebook or laptop computer, netbook, a tablet computer, e-book reader, global positioning system (GPS) device, camera, personal digital assistant (PDA), handheld electronic device, cellular telephone, smartphone, wearable device, other suitable electronic device, or any suitable combination thereof. This disclosure contemplates any suitable client device 104. A client device 104 may enable a network user at a client device 104 to access a network 106. A client device 104 may enable its producing entity 108 to communicate with other producing entities 108 at other client devices 104, such as via messaging application 120.

The connection network system 100 comprises a client application 110. In particular embodiments, a client device 104 may include a client application 110, which may be a web browser, and may have one or more add-ons, plug-ins, or other extensions. A producing entity 108 at a client device 104 may enter a Uniform Resource Locator (URL) or other address directing a web browser to a particular server device 102 such as a server or server data center for a connection network platform 112, and the web browser may generate a Hyper Text Transfer Protocol (HTTP) request and communicate the HTTP request to the server device 102. The server device 102 may accept the HTTP request and communicate to a client device 104 one or more Hyper Text Markup Language (HTML) files responsive to the HTTP request. The client device 104 may render a web interface (e.g. a webpage) based on the HTML files from the server for presentation via an electronic display of the client device 104 to the producing entity 108. This disclosure contemplates any suitable source files. As an example and not by way of limitation, a web interface may be rendered from HTML files, Extensible Hyper Text Markup Language (XHTML) files, or Extensible Markup Language (XML) files, according to particular needs. Such interfaces may also execute scripts such as, for example and without limitation, those written in JAVASCRIPT, JAVA, MICROSOFT SILVERLIGHT, combinations of markup language and scripts such as Asynchronous JAVASCRIPT (AJAX), and XML), and the like. Herein, reference to a web interface encompasses one or more corresponding source files (which a browser may use to render the web interface) and vice versa, where appropriate.

In particular embodiments, the client application 110 may be an application operable to provide various computing functionalities, services, and/or resources, and to send data to and receive data from the other entities of the network 106, such as the connection network platform 112. For example, the client application 110 may be a client connection network application tightly integrated with the connection network platform 112, a messaging application 120 for messaging with producing entities 108 of a messaging network or system, a web browser application, an internet searching application, and so forth. Non-limiting examples of client application 110 include a cloud-based suite of business applications, such as enterprise resource planning (ERP), customer relationship management (CRM, productivity applications, and AI tools designed to help organizations unify their data, streamline operations and workflows, improve customer engagement, and make data-driven decisions to drive digital transformation and remain competitive in a dynamic marketplace.

In particular embodiments, the client application 110 may be storable in a memory and executable by a processor circuitry of the client device 104 to render user interfaces, receive user input, send data to and receive data from the connection network platform 112. The client application 110 may generate and present user interfaces to a user via an electronic display of the client device 104. For example, the client application 110 may generate and present a GUI 142 based at least in part on information received from the server device 102, the connection network platform 112, and/or another device or system (e.g., a third party server) via the network 106. The GUI 142 may include various GUI elements for the client application 110 to drive interaction between the producing entity 108, the client device 104, and the server device 102. When the client application 110 is a business application, such as an ERP or CRM, the GUI 142 may comprise GUI elements for one or more notifications 144, entity identifiers 146, recommendations 148, and feedback 150.

The connection network system 100 comprises a network 106. This disclosure contemplates any suitable network 106. As an example and not by way of limitation, one or more portions of a network 106 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. A single network 106 may comprise multiple networks 106.

In operation, a producing entity 108 interacts with a client application 110 of the client device 104 to access applications and services provided by a connection network platform 112 of the server device 102 via one or more links 152 of the network 106. The links 152 may connect each client device 104 to the connection network platform 112 via the network 106. This disclosure contemplates any suitable link 152. In particular embodiments, one or more links 152 include one or more wireline (such as for example Digital Subscriber Line (DSL) or Data Over Cable Service Interface Specification (DOC SIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 152 each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 152, or a combination of two or more such links 152. Links 152 need not necessarily operate at the same throughout. One or more first links 152 may differ in one or more respects from one or more second links 152.

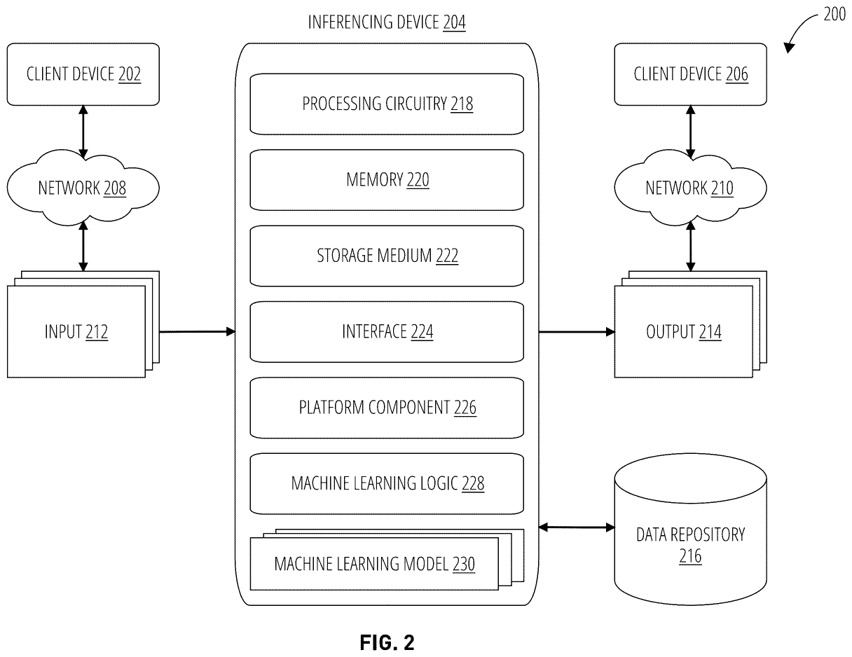

FIG. 2 illustrates an embodiment of a system 200. The system 200 is suitable for implementing one or more embodiments as described herein. In one embodiment, for example, the system 200 is an AI/ML system suitable for implementing models described with reference to any of the preceding description.

The system 200 comprises a set of M devices, where M is any positive integer. FIG. 2 depicts three devices (M=3), including a client device 202, an inferencing device 204, and a client device 206. The inferencing device 204 communicates information with the client device 202 and the client device 206 over a network 208 and a network 210, respectively. The information may include input 212 from the client device 202 and output 214 to the client device 206, or vice-versa. In one alternative, the input 212 and the output 214 are communicated between the same client device 202 or client device 206. In another alternative, the input 212 and the output 214 are stored in a data repository 216. In yet another alternative, the input 212 and the output 214 are communicated via a platform component 226 of the inferencing device 204, such as an input/output (I/O) device (e.g., a touchscreen, a microphone, a speaker, etc.).

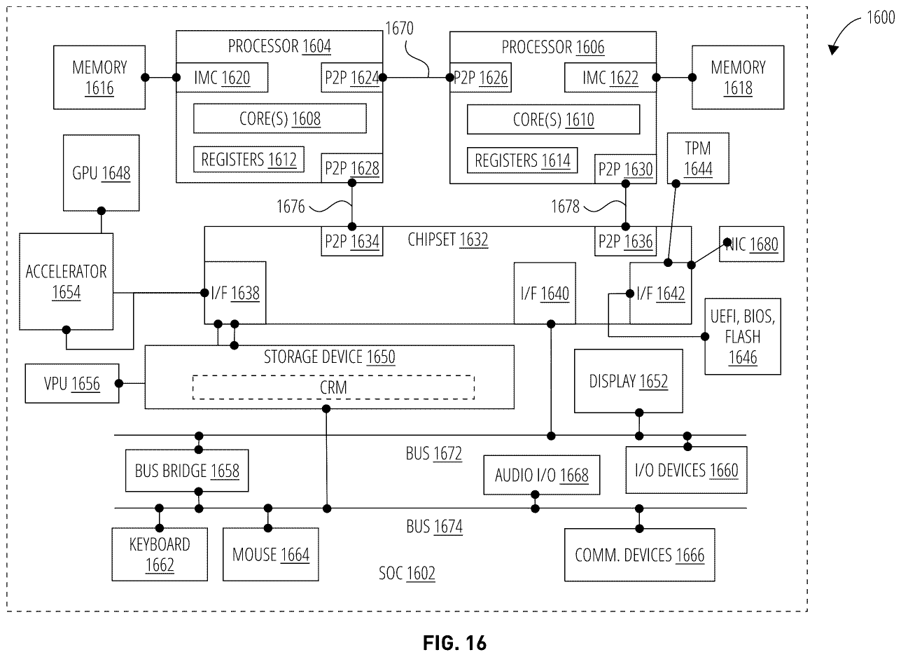

As depicted in FIG. 2, the inferencing device 204 includes processing circuitry 218, a memory 220, a storage medium 222, an interface 224, a platform component 226, ML logic 228, and an ML model 230. In some implementations, the inferencing device 204 includes other components or devices as well. Examples for software elements and hardware elements of the inferencing device 204 are described in more detail with reference to a computing architecture 1600 as depicted in FIG. 16. Embodiments are not limited to these examples.

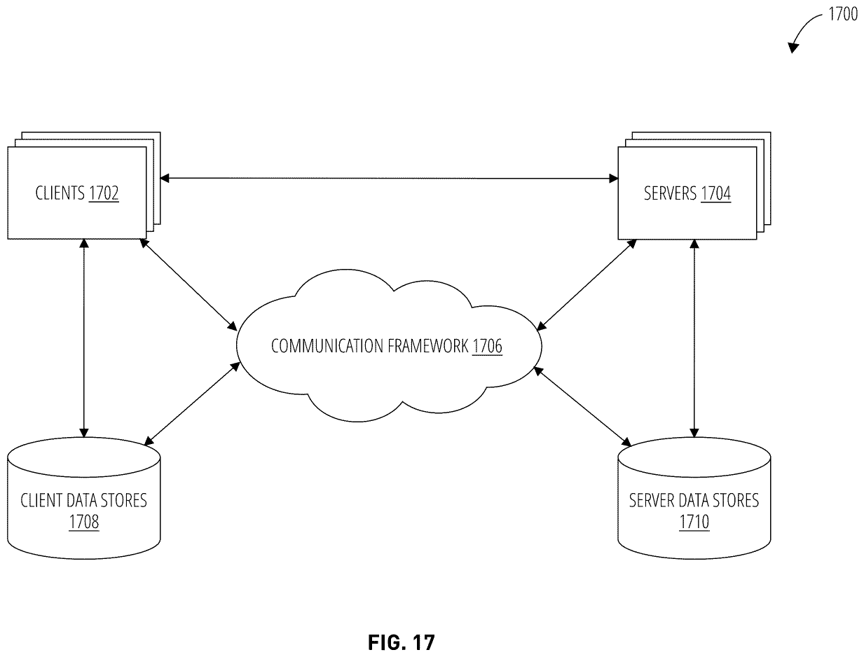

The inferencing device 204 is generally arranged to receive an input 212, process the input 212 via one or more AI/ML techniques, and send an output 214. The inferencing device 204 receives the input 212 from the client device 202 via the network 208, the client device 206 via the network 210, the platform component 226 (e.g., a touchscreen as a text command or microphone as a voice command), the memory 220, the storage medium 222 or the data repository 216. The inferencing device 204 sends the output 214 to the client device 202 via the network 208, the client device 206 via the network 210, the platform component 226 (e.g., a touchscreen to present text, graphic or video information or speaker to reproduce audio information), the memory 220, the storage medium 222 or the data repository 216. Examples for the software elements and hardware elements of the network 208 and the network 210 are described in more detail with reference to a communications architecture 1700 as depicted in FIG. 17. Embodiments are not limited to these examples.

The inferencing device 204 includes ML logic 228 and an ML model 230 to implement various AI/ML techniques for various AI/ML tasks. The ML logic 228 receives the input 212, and processes the input 212 using the ML model 230. The ML model 230 performs inferencing operations to generate an inference for a specific task from the input 212. In some cases, the inference is part of the output 214. The output 214 is used by the client device 202, the inferencing device 204, or the client device 206 to perform subsequent actions in response to the output 214.

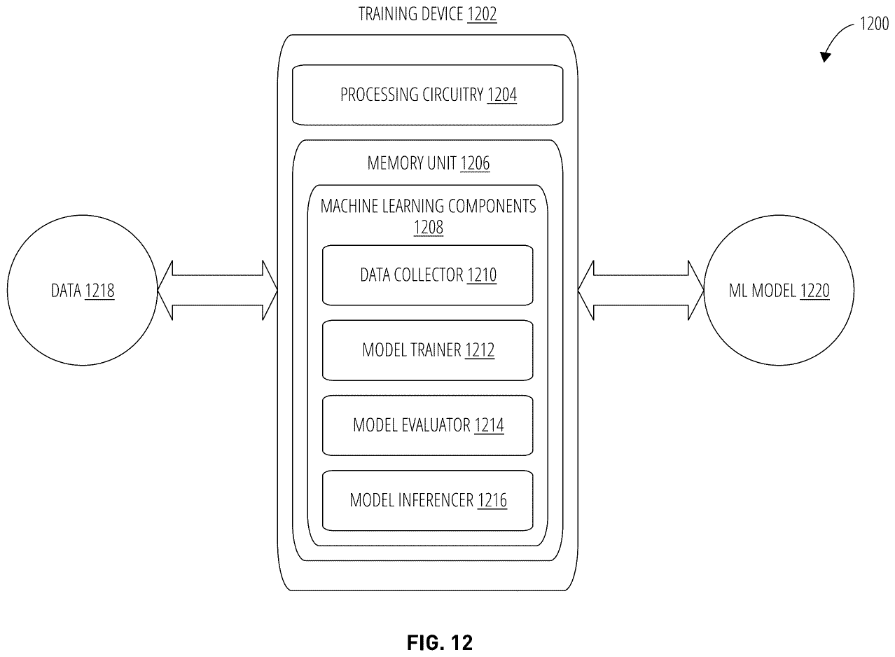

In various embodiments, the ML model 230 is a trained ML model 230 using a set of training operations. An example of training operations to train the ML model 230 is described with reference to FIG. 12.

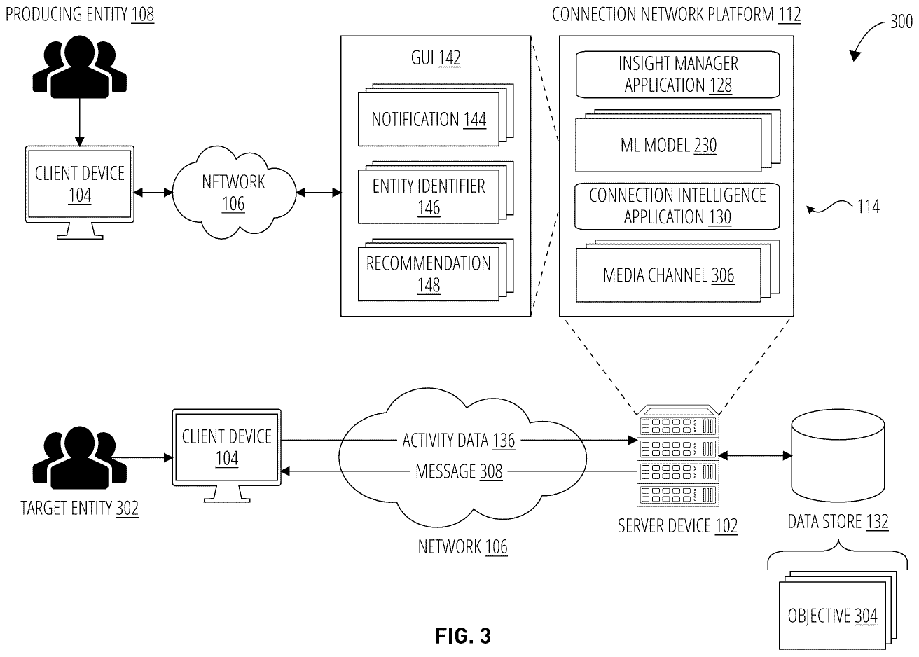

FIG. 3 illustrates a logic diagram 300. The logic diagram 300 is an example of a data flow and components for the connection network platform 112 that are designed to deliver one or more recommendations 148 in accordance with one or more objectives 304 associated with a target entity 302 to a producing entity 108 of the connection network system 100. The logic diagram 300 delivers the recommendations 148 in a targeted manner. In addition, the logic diagram 300 may deliver content items 140. The content items 140 may comprise, for example, recommendations, advertisements, content, messages, suggestions, hyperlinks, files, job postings, articles, and any other content offered by the connection network platform 112 of the connection network system 100.

In various embodiments, the connection network system 100 may use the logic diagram 300 to provide an insight service via an insight manager application 128 and/or connection intelligence application 130, either alone or in combination, to its producing entities 108 (e.g., individuals, members, entities, groups, etc.). The logic diagram 300 is generally designed to deliver electronic recommendations 148 to producing entities 108 based, at least in part, on entity data 134 and activity data 136 of target entities 302 of the connection network system 100. In particular, the logic diagram 300 may deliver recommendations 148 specifically targeted to a producing entity 108 based on entity data 134 or activity data 136 of one or more target entities 302. For instance, a producing entity 108 such as an account representative may manage a number of accounts for target entities 302 (e.g., business accounts for business entities or consumer entities) to sell business-to-business (B2B) or business-to-consumer (B2C) products or services of the producing entity 108 using the connection network platform 112 of the connection network system 100 in accordance with a series of objectives 304 associated with the account, a product, or a service of the producing entity 108 to the target entity 302 using the connection network system 100.

The logic diagram 300 comprises a set of one or more client devices 104, server devices 102, and data stores 132. A client device 104 and a server device 102 may communicate information via a network 106. The client device 104 may comprise an electronic device, such as a smartwatch, smartphone, tablet, laptop computer, desktop computer, and so forth. The server device 102 may be implemented as a server in a data center, such as a cloud computing system or edge computing system. The client device 104 and the server device 102 may be implemented using an architecture as described in FIG. 16. The network 106 may be implemented using an architecture as described in FIG. 17. Embodiments are not limited to these example implementations.

The server device 102 implements a connection network platform 112 as described with reference to FIG. 1. In one embodiment, the connection network platform 112 includes at least one processor circuitry, at least one memory unit operably coupled to the processor circuitry, the memory unit including instructions executable by the at least one processor circuitry, and an ML model 230 comprising parameters and/or hyperparameters stored in the at least one memory unit. In one embodiment, for example, the ML model 230 is implemented as a causal model for an AI system implemented by the logic diagram 300 to offer a network service such as a talent management service by the insight manager application 128 of the connection network platform 112. The insight manager application 128 may cause presentation of information on the GUI 142, such as providing a notification 144 associated with an entity identifier 146 of a target entity 302 regarding a recommendation 148 for a target entity 302 to a producing entity 108 via a client device 104. The recommendation 148 may comprise multimedia information describing a suggested interaction between the producing entity 108 and the target entity 302 in accordance with a target set of objectives 304. The interaction may take place over one or more media channels 306 to the client device 104 of the target entity 302, such as initiating a voice call, a video call, a chat session, sending a message 308, delivering content items 140 (e.g., advertisements, promotions, etc.), and other communications techniques. The target entity 302 may interact with the producing entity 108 via a GUI presented on the client device 104 of the target entity 302.

The server device 102 may include connection network platform 112 implementing a network service to producing entity 108 of the connection network platform 112. Professional networking platforms offer a wide range of networking services to facilitate connections, career development, and knowledge sharing. Some examples of a network service offered by the connection network platform 112 include without limitation: (1) users can create a professional profile to showcase their skills, work experience, education, and professional accomplishments; (2) users can connect with colleagues, industry professionals, and potential employers to expand their professional network; (3) messaging capabilities for direct communication between users, facilitating professional conversations and networking opportunities; (4) users can join and participate in industry-specific groups and communities to engage in discussions, share insights, and network with like-minded professionals; (5) search job listings and recruiting tools for users to search for employment opportunities, apply for jobs, and connect with talent; (6) users can share industry-related content, articles, and professional updates to showcase expertise and engage with their network; and (7) access learning resources, courses, and training programs to support ongoing professional development and skill enhancement. These networking services are designed to help professionals connect, collaborate, and grow their careers. Embodiments are not limited to these examples.

In an example process, the connection network platform 112 obtains activity data 136 from target entities 302 via the client device 104. The target entities 302 interact with the connection network platform 112 via a GUI of the connection network platform 112. In some cases, portions of the GUI are displayed on a personal machine or client device 104 of a target entity 302. The activity data 136 represents various actions, activities or behaviors of one or more target entities 302. For example, activity data 136 may represent data collected as the target entities 302 interact with various GUI elements served via the server device 102. In another example, the activity data 136 may represent data collected as the target entities 302 interact with other products or services offered by the connection network platform 112, such as searching for job postings, sending messages to other target entities 302, recommending posts by producing entities 108, sending and responding to connection requests, playing online games, and other activities organic to use of the connection network platform 112. Session data is any activity data 136 collected during a defined session time window, such as activity of the user over a 24 hour period or some other time interval. For example, a target entity 302 may interact with the client device 104 to communicate with the connection network platform 112 of one or more of the server devices 102 to access one or more content items 140 representing products or services of the insight manager application 128 stored by the data store 132. The target entities 302 may perform various activities, such as browsing a web site, searching for a job posting, reading content, watching a streaming video, messaging other members, clicking on an GUI item, interacting with an advertisements, or engaging in electronic commerce. The session data, including the activity data 136, is transferred between the client device 104 and the server device 102.

The message 308 is delivered through one or more of the media channels 306. A media channel refers to a specific platform or medium through which targeted content, such as advertisements, are disseminated to a target user. Media channels 306 can include various forms of digital and traditional media such as websites, mobile applications, social media platforms, television, radio, print publications, and outdoor advertising spaces. Each media channel possesses its own unique characteristics and user demographics, allowing advertisers to tailor their messages to reach the desired target user effectively. Message providers, such as advertisers, often choose certain media channels based on factors such as user engagement, reach, cost, and the compatibility of the channel with their target market. An example of the media channel 306 is a social media platform or a professional media platform, or some other mode of information transfer within the platform.

The connection network platform 112 or components thereof are implemented on a server. A server provides one or more functions to users linked by way of one or more of the various networks. In some cases, the server includes a single microprocessor board, which includes a microprocessor responsible for controlling all aspects of the server. In some cases, a server uses microprocessor and protocols to exchange data with other devices/users on one or more of the networks via hypertext transfer protocol (HTTP), and simple mail transfer protocol (SMTP), although other protocols such as file transfer protocol (FTP), and simple network management protocol (SNMP) can also be used. In some cases, a server is configured to send and receive hypertext markup language (HTML) formatted files (e.g., for displaying web pages). In various embodiments, a server comprises a general purpose computing device, a personal computer, a laptop computer, a mainframe computer, a super computer, or any other suitable processing apparatus.

The data store 132 is an organized collection of data. For example, the data store 132 stores data in a specified format known as a schema. The data store 132 can be structured as a single database, a distributed database, multiple distributed databases, or an emergency backup database. In some cases, a database controller manages data storage and processing in data store 132. In some cases, a user interacts with the database controller. In other cases, the database controller operates automatically without user interaction. The data store 132 is configured to store various content items 140. The content items 140 include any multimedia information suitable for presentation by the client device 104, such as HTML code to present websites, text, images, video, messages, advertisements, and so forth. In addition, the data store 132 may also store application data comprising information and data used by the connection network platform 112. For example, data store 132 is configured to store user session data, profiles, embeddings, budgets, cached application programming interface (API) requests, machine learning model parameters, training data, and other data.

Network 106 facilitates the transfer of information between connection network platform 112, data store 132, and client device 104. Network 106 is a computer network configured to provide on-demand availability of computer system resources, such as data storage and computing power. In some examples, the network 106 provides resources without active management by the producing entities 108. The network 106 includes data centers available to many users over the Internet. Some large cloud networks have functions distributed over multiple locations from central servers. A server is designated an edge server if it has a direct or close connection to a producing entities 108. In some cases, a cloud is limited to a single organization. In other examples, the cloud is available to many organizations. In one example, the network 106 includes a multi-layer communications network comprising multiple edge routers and core routers. In another example, the network 106 is based on a local collection of switches in a single physical location.

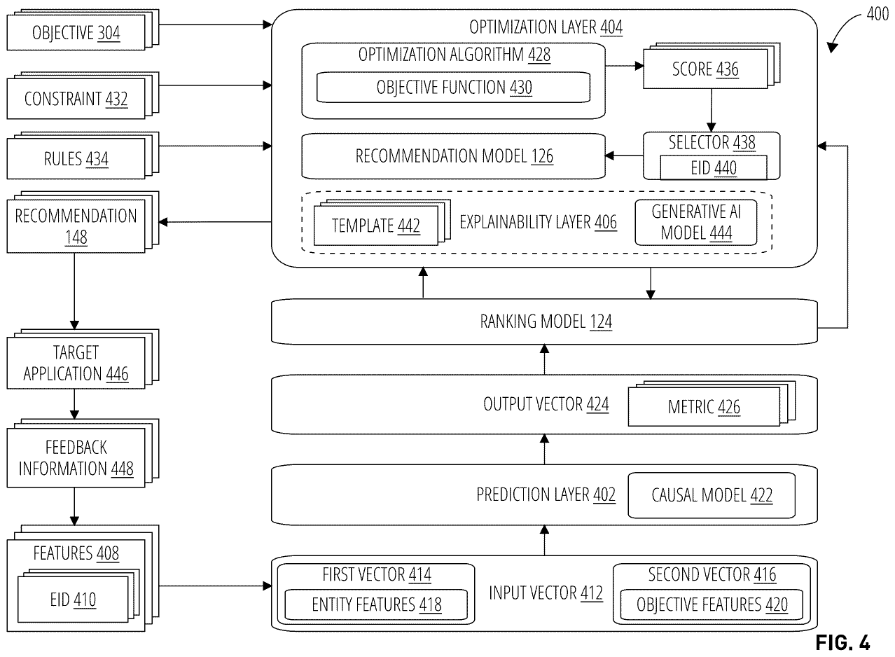

FIG. 4 illustrates an ML architecture 400 for the logic diagram 300. Specifically, the ML architecture 400 is an example of multiple ML models 230 used by the logic diagram 300 to generate recommendations 148. Embodiments are not limited to this example.

As previously described, the ML architecture 400 implements one or more ML models 230 trained and deployed to perform inferencing operations in support of a network service 114, such as the insight manager application 128 and/or the connection intelligence application 130. In some embodiments, for example, the insight manager application 128 provides insights for a connection intelligence application 130. In some embodiments, for example, both the insight manager application 128 and the connection intelligence application 130 are integrated to provide a single unified network service. Embodiments are not limited to certain network services such as insight services or connection intelligence services, and can be implemented for any network services provided by a connection network system, such as a talent management service, among other types of network services. Embodiments are not limited in this context.

In some embodiments, the insight manager application 128 may generate insights for a producing entity 108 to sell products or services to a target entity 302. In various embodiments, one or both of the producing entity 108 and the target entity 302 may be members (e.g., users or subscribers) of the connection network system 100. As such, the connection network system 100 stores entity data 134 and activity data 136 for one or both entities. The insight manager application 128 may use this data to generate, at least in part, insights such as recommendations 148 for the connection intelligence application 130. In some embodiments, the producing entity 108 is a business entity (e.g., a company) and the target entity 302 is a consumer entity (e.g., a user) in a business-to-consumer (B2C) model. In some embodiments, the producing entity 108 is a business entity and the target entity 302 is another business entity in a business-to-business (B2B) model.

The insight manager application 128 may implement or use a single or multi-layer prediction model to generate a set of candidate target entities 302, an optimization algorithm 428 implementing an objective function 430 to optimize the set of candidate target entities (e.g., filter or identify a subset) and select a target entity ready for an action from the set of candidate target entities, and a recommendation model 126 to generate a recommendation 148 for the target entity 302. The recommendation 148 may be generated in a human-readable form, such as in a natural human language.

The insight manager application 128 may implement a flexible and modular computing architecture or framework that includes one or more ML models 230, such as a causal model 422 for a prediction layer 402, a ranking model 124, and a recommendation model 126. Further, an optimization layer 404 may implement an optimization algorithm 428 for an objective function 430 to further refine the output of the prediction layer 402. The insight manager application 128 may assist the connection intelligence application 130 in identifying a target entity 302 from a set of candidate target entities (e.g., individuals, users, members, subscribers, companies, groups, organizations, agencies, etc.), via entity identifiers 410 associated with the candidate target entities 302, suitable for engagement or interaction by a producing entity 108. The connection intelligence application 130 may also provide a recommendation 148 for the producing entity 108 regarding the target entity 302, such as an action to take for the target entity 302, when to take such action, customized content items 140 for the target entity 302, statistical metrics associated with the target entity 302, and other types of data associated with the target entity 302 and relevant in a decision-making process for the producing entity 108.

Some embodiments combine the prediction layer 402 and the optimization layer 428 in a new and unique manner. When comparing tree-based causal machine learning approaches (e.g., such as meta-learners that utilize decision trees or random forests) to other predictive modeling techniques, several advantages emerge, especially in scenarios to optimize multiple objectives like user engagement and monetization. For example, tree-based models excel at uncovering intricate, non-linear relationships between features and outcomes. Unlike linear models, which assume additive and linear relationships, tree-based methods can easily model complex feature interactions and subtle patterns. This is particularly useful when engagement and monetization depend on multifaceted user behaviors and contextual factors that do not follow simple linear trends. Further, because causal models split data along the most predictive features at each node, tree-based methods inherently perform a form of feature selection. This can be invaluable when dealing with large, diverse data sets that include user attributes, behavioral histories, and contextual signals. Moreover, trees are relatively robust to outliers and can handle missing data more gracefully than many other model types, simplifying data preparation and preprocessing. Causal machine learning techniques like meta-learners may be used to estimate how different interventions (e.g., personalized recommendations, UI changes, pricing adjustments) affect various outcomes. Tree-based meta-learners (such as causal forests) can segment the population into subgroups with distinct responses. This allows decision-makers to identify which types of users will respond best to certain interventions, thus optimizing for engagement and monetization in a more nuanced, user-specific manner. While still more complex than simple linear models, tree-based structures are relatively easier to interpret compared to deep neural networks or other “black-box” models. The hierarchical splitting logic can show which user attributes or content characteristics lead to higher engagement or revenue. This segmentation provides intuitive, rule-based insights into where and how to intervene. For instance, you might discover that users with certain browsing patterns respond strongly to a particular promotional offer, guiding more targeted and effective strategies. In scenarios to balance multiple objectives-such as achieving both higher engagement and increased monetization-tree-based methods can help understand trade-offs. Examining the model's splits and terminal nodes can identify subpopulations or conditions that yield favorable outcomes across both objectives. This makes it easier to formulate multi-criteria strategies, for example, by focusing on user segments that not only engage deeply but also contribute to revenue at acceptable cost levels. Many other modeling approaches (e.g., linear regression, logistic regression) rely on strong parametric assumptions and predefined functional forms. Tree-based models make fewer such assumptions, letting the data guide the model structure. This can be particularly advantageous in dynamic domains where user behaviors and market conditions evolve quickly and unpredictably.

While tree-based causal machine learning models provide superior prediction results, their advantage is amplified using the prediction layer 402 in combination with the technical advantages provided by an objective function 430 of the optimization layer 428. For example, using an objective function 430 to guide model training provides a formal, quantitative way to optimize for the desired outcomes. The objective function 430 translates model performance criteria, such as accuracy, precision, recall, revenue maximization, or minimization of prediction error, into a single, numeric metric. This clarity helps ensure the training process focuses on a well-defined target rather than vague or subjective criteria. Once defined, the objective function 430 enables algorithmic optimization methods (like gradient descent or evolutionary algorithms) to systematically improve model parameters. These methods iteratively adjust the model's internal structure (weights, splits, etc.) to minimize or maximize the objective, leading to a more efficient and reproducible training process than ad-hoc adjustments. Complex decision-making tasks often involve balancing multiple objectives, such as accuracy and fairness, or engagement and monetization. By incorporating these factors into a single, composite objective function 430, either through weighted combinations, constraints, or multi-objective optimization techniques, developers can guide the model towards solutions that satisfy multiple criteria simultaneously. With the objective function 430, it becomes straightforward to compare different models, configurations, or experiments. A designer can directly assess which model performs better by looking at the objective value, enabling more informed model selection and the establishment of performance benchmarks. Because objective functions distill performance into a concise numerical target, improvements can be tracked over time. As the model is updated or retrained on new data, consistent gains or losses can be observed, providing clear evidence of progress or highlighting where further refinement is needed. When the objective function 430 encodes certain trade-offs (for instance, favoring precision over recall), it makes those trade-offs explicit. This clarity can aid stakeholders in understanding why the model behaves as it does, as well as guiding decisions about how to rebalance priorities.

The connection intelligence application 130, with the assistance of the insight manager application 128, is generally designed to identify, generate and deliver electronic recommendations 148 to entities (e.g., producing entities 108) based, at least in part, on entity data 134 and activity data 136 of the producing entities 108 and/or target entities 302 of the connection network system 100. In particular, the connection intelligence application 130 may utilize one or more ML models 230 to deliver recommendations 148 to a producing entity 108 (e.g., an account representative, sales agent, marketing manager, etc.) to perform an action for a target entity 302 (e.g., a customer, a business, a user, etc.) to further a defined objective 304 associated with the target entity 302. Non-limiting examples of actions may include engagement such as an entity to contact, topics to discuss, offers to provide, and otherwise prompting an interaction or “touchpoint” between the producing entity and the target entity, such as conducting a phone call, sending a message, delivering a content item like an advertisement, providing a promotion, and so forth. Non-limiting examples of objectives 304 may include optimizing potential revenue from an entity, increasing customer engagement, selling a particular product or service, initiating or renewing a subscription, and so forth. The insight manager application 128 and connection intelligence application 130 are designed to interoperate in order to identify a given account for a specific action at a defined time. Utilizing machine learning, the insight manager application 128 and the connection intelligence application 130 can streamline and eliminate the need for manual categorization of customers and the identification of accounts experiencing declining engagement. These approaches empower account representatives to navigate the technical complexities of the sales process effectively, leading to successful client acquisitions and satisfaction.

In some embodiments, the insight manager application 128 and/or connection intelligence application 130 implements the ML architecture 400 that includes, among other elements, a prediction layer 402, an optimization layer 404, and an explainability layer 406. The prediction layer 402 is generally designed to predict metrics 426 representing certain objectives 304 (e.g., business objectives) associated with target entities 302, such as monetization potential or customer engagement, for example. The prediction layer 402 may implement an ML model 230 such as a causal model 422 (e.g., a doubly-robust estimator) to estimate an incremental value from sales engagement on one or more objectives 304, such as monetization effort and engagement, for example. A ranking model 124 may use the metrics 426 to rank entity identifiers 410 using a first ranking algorithm, which are then output to an optimization layer 404. The optimization layer 404 is generally designed to implement an objective function 430 to optimize the metrics 426 for the ranked target entities 302. The optimization layer 404 may also use a set of rules, such as rules 434 including hard rules and soft rules, as part of the constraints 432 for the objective function 430. The objective function 430 outputs a set of scores for the entity identifiers 146. The ranking model 124 may use the scores to rank (or re-rank) the entity identifiers 410 using a second ranking algorithm. Once the entity identifiers 410 are ranked, the optimization layer 404 provides supporting information including whether each entity identifier 410 is associated with an account that should be recommended due to the objectives 304 (e.g., monetization or engagement estimates) and constraints 432. A recommendation model 126 may then generate one or more recommendations 148 for one or more entity identifiers 410 associated with accounts that need action to further the objectives 304. The recommendation model 126 may generate the recommendations 148 using one or more defined template 442 (e.g., for a customer, product, service, action, touchpoint, etc.), a generative artificial intelligence (GAI) model such as generative AI model 444 (e.g., a large language model), or a combination of both. Finally, the explainability layer 406 enhances a trust and/or confidence value to the connection intelligence application 130 by providing natural language expressions (e.g., human-readable explanations) for the recommendations 148 it generates. It takes the features 408 and output from the prediction layer 402 and/or optimization layer 404 and it generates explanations or comments via template 442 and/or the generative AI model 444, such as global feature importance, instance level feature importance, and/or a time series summary.

By way of example, as depicted in FIG. 4, the ML architecture 400 comprises an input vector 412, a prediction layer 402, an output vector 424, a ranking model 124, and an optimization layer 404. The optimization layer 404 comprises an optimization algorithm 428 implementing an objective function 430, a set of rules 434, and a set of ML models 230 including a recommendation model 126 and a generative AI model 444.

The prediction layer 402 may implement an ML model 230, such as a causal model 422. A causal model 422 is a type of ML model 230 designed to infer and quantify the cause-and-effect relationships between variables, going beyond traditional predictive models that capture correlations. At its core, a causal model 422 typically employs Directed Acyclic Graphs (DAGs) to represent the underlying causal structure, where nodes denote variables and edges indicate causal influences. Key components include treatment variables (interventions), outcome variables, and confounders that may bias the estimated effects if not properly controlled. To ensure accurate causal inference, the causal model 422 relies on assumptions such as exchangeability (no unmeasured confounders), consistency (the potential outcome under the observed treatment is the observed outcome), and the Stable Unit Treatment Value Assumption (SUTVA). Techniques like do-calculus and instrumental variables are often employed to identify and estimate causal effects, ensuring that the relationships modeled reflect true causality rather than mere association.

For implementation, causal machine learning models integrate traditional ML algorithms with causal inference methodologies. Causal forests, for example, extend random forests to estimate heterogeneous treatment effects by partitioning the data based on causal heterogeneity. Propensity score matching and inverse probability weighting are used to balance covariates between treated and control groups, mitigating confounding bias. Additionally, frameworks like counterfactual reasoning enable the estimation of what would have happened under different treatment scenarios, which is crucial for applications such as personalized medicine or policy evaluation. Model evaluation in causal ML often involves assessing the identifiability of causal effects and validating assumptions through techniques like sensitivity analysis. By incorporating these causal principles, the causal model 422 can predict outcomes accurately and also provide actionable insights into the mechanisms driving those outcomes, facilitating more informed decision-making.

In some embodiments, the causal model 422 is implemented as a doubly robust estimator. A doubly robust estimator in causal inference is a statistical method used to estimate treatment effects that combines two approaches: modeling the outcome and modeling the treatment assignment (propensity score). The key advantage of a doubly robust estimator is that it remains consistent if either the outcome model or the treatment model is correctly specified, but not necessarily both. This means that as long as one of the models is accurately capturing the true relationship, the estimator will provide an unbiased estimate of the causal effect. This property offers an additional layer of protection against model misspecification, which is particularly valuable in observational studies where the true models are unknown. In practice, the doubly robust estimator works by first estimating the propensity scores, such as the probabilities of receiving the treatment given covariates, and then using these scores to weight the data or adjust the estimates from the outcome model. Specifically, it involves calculating an augmented inverse probability weighted estimator that integrates both the propensity score model and the outcome regression model. Implementing a doubly robust estimator involves fitting both models separately and then combining them according to the doubly robust formula. This approach enhances the reliability of causal effect estimation by mitigating biases due to confounding variables, making it a powerful tool in the toolbox of causal machine learning and statistical analysis.

In some embodiments, the causal model 422 is implemented as a meta-learner. A meta-learner in causal modeling is an algorithmic framework that orchestrates base machine learning models to estimate causal effects, such as the impact of a treatment or intervention on an outcome variable. Unlike traditional predictive models, meta-learners adjust for confounding variables to uncover causal relationships in observational data. For example, to assess how a new software feature (treatment) affects user engagement (outcome), a meta-learner would predict user engagement both with and without the feature while accounting for factors like user demographics and prior usage patterns. Common meta-learners include the S-Learner, which fits a single model incorporating the treatment indicator; the T-Learner, which trains separate models for treated and control groups; and the X-Learner, which combines these approaches to handle unbalanced treatment assignments. For instance, the causal model 422 may be implemented as a T-Learner to estimate the causal effect of a marketing campaign by building separate machine learning models for customers who received the campaign and those who did not. By computing the difference in predicted outcomes from these models, the output of the causal model 422 can be used to infer the campaign's impact on sales, enabling data-driven decisions even when randomized controlled trials are not feasible.

The causal model 422 of the prediction layer 402 receives as input an input vector 412 comprising a set of features 408 associated with a set of entity identifiers 410 (e.g., entities such as users or members) of the connection network platform 112 of the connection network system 100. As previously described, the data store 132 stores different types of data for the connection network platform 112 of the connection network system 100, including entity data 134, activity data 136, connection graph data 138, and content items 140. To convert raw data from the data store 132 into input vectors for the prediction layer 402, different types of features 408 are first extracted and processed based on their data types. Numerical features can often be used directly but may require normalization or scaling to ensure they contribute equally to the model's learning process. Categorical features are transformed using encoding techniques such as one-hot encoding, label encoding, or embedding methods to convert categories into numerical representations. Text data is processed using natural language processing techniques like tokenization, stemming, and converting words into numerical vectors using methods like Term Frequency-Inverse Document Frequency (TF-IDF) or word embeddings (e.g., Word2Vec, GloVe). Image and audio data require feature extraction methods like convolutional neural networks (CNNs) for images or spectrograms and feature extraction algorithms for audio, transforming raw signals into numerical feature vectors that capture essential patterns.

Once all features 408 are numerically represented, they are consolidated into a unified input vector 412 for the causal model 422 of the prediction layer 402. This involves concatenating the processed features while ensuring that the input dimensions align with model expectations. Preprocessing steps such as handling missing values, feature scaling, and dimensionality reduction (e.g., using PCA) may be applied to optimize the input vector's quality. The final input vector is a numerical array where each element represents a feature, ready to be fed into the causal model 422 for training or inference. Proper feature engineering and transformation are critical, as they directly affect model ability to learn from the data and make accurate predictions.

The input vector 412 comprises two vectors with different types of features 408. A first vector 414 comprises a set of entity features 418. The entity features 418 represent various types of data associated with the target entities 302. A second vectors 416 comprises a set of objective features 420. The objective features 420 represent various types of data associated with a set of objectives 304 associated with the target entities 302. An embedding layer or feature extraction layer extracts the features 408 from the entity data 134 and/or activity data 136 in the data store 132, and it generates the input vector 412 with the first vector 414 of entity features 418 and the second vector 416 of objective features 420 for input into the prediction layer 402.

The prediction layer 402 is generally designed to predict a set of metrics 426 representing certain objectives 304 associated with the entity identifiers 410. In some embodiments, the prediction layer 402 has two objectives 304, such as monetization potential and customer engagement. The first objective 304 is to identify accounts that would benefit the most from sales outreach and predict monetization potential (e.g., life cycle revenue). The second objective 304 is predict customer engagement, which could be particularly important for customers who do not renew at a renewal time.

The prediction layer 402 may implement the causal model 422 (e.g., a doubly-robust estimator) to estimate an incremental value from sales engagement on the objectives 304, such as monetization effort and customer engagement, for example. The causal model 422 of the prediction layer 402 is designed to predict a future (T+1) monetization potential and customer engagement. The engagement component is implemented because of customers who are not due to renew in a defined time period (e.g., a next quarter) or have upsell opportunities, and engagement is a core indicator and driver for sales representatives to prioritize. The definition of engagement may differ across different products. For example, for hiring products or services of a talent management system, there may be two business lines of products, such as a number of recruiter seats and a number of job slots, for a talent management system. Accordingly, engagement may cover both recruiter product and job slot product, which are reflected via metrics such as recruiter index and job slot utilization parameters.

The causal model 422, implemented as a doubly robust estimator, may estimate metrics 426 such as an incremental value from sales engagement on both a monetization effort and engagement, using Equation (1) and Equation (2), as follows:

$${Δ}_{monetization} = P ( monetization \vert sales outreach , X ) - P ( monetization \vert no sales outreach , X ) \qquad EQUATION ( 1 )$$

$${Δ}_{engagement} = P ( engagement \vert sales outreach , X ) - P ( engagement \vert no sales outreach , X ) \qquad EQUATION ( 2 )$$

In Equation (1) and Equation (2), X is the customer feature vector. The outputs from this layer are values Δ_{monetization} and Δ_{engagement}, For example, the Δ_{monetization} may be a prediction of an objective 304 for a monetization of revenue from a customer and/or a value representing a prediction of sales engagements impact on upsell or churn. The Δ_{engagement} may be a prediction of an objective 304 for an engagement of a customer and an engagement index for a defined time period (e.g., days, weeks, months, etc.). The predictions may be stored as account level monetization predictions and account level engagement predictions in the data store 132.

In some embodiments, the raw output (e.g., real number) may be normalized. For example, these values may be normalized into a format of normalized indices from −100 to 100, where a negative index indicates churn and lower level of engagement, and a positive index means upsell and higher engagements. Different normalization schemes may be implemented for the normalized indices as needed for a given implementation.

For ease of explainability, the prediction layer 402 may implement separate causal models 422 for sub-objectives of an objective 304. For example, given an objective 304 of engagement, an engagement causal model 422 may be implemented for each engagement metric, such as a first engagement causal model 422 for a first engagement metric, a second engagement causal model 422 for a second engagement metric, and so forth. In this case, the ranking model 124 may rank the output of each of the separate causal models 422 under each sub-objective. In some embodiments, the engagement component may be simplified and reduced to P(engagement|X).

The prediction layer 402 may use the causal model 422 to generate an output vector 424 comprising a set of one or more metrics 426 associated with one or more entity identifiers 410 from the input vector 412. A metric 426 may comprise measurements or values for an objective 304. In some embodiments, objectives 304 may comprise a monetization objective and/or an engagement objective. In this case, the metrics 426 may comprise a monetization metric and an engagement metric. Other types of objectives 304 and metrics 426 may be implemented for the prediction layer 402. Embodiments are not limited in this context.

The ranking model 124 may receive the output vector 424 with the metric 426. The ranking model 124 may use the metric 426 to rank entity identifiers using a first ranking algorithm, which are then output to an optimization layer 404.

The optimization layer 404 is generally designed to implement an optimization algorithm 428 for an objective function 430 to optimize the metrics 426 for the ranked entity identifiers 410. The optimization layer 404 may also use a set of rules, including hard rules and soft rules, implemented as a set of rules 434 for the objective function 430. The objective function 430 outputs a set of scores 436 for the entity identifiers 410. The ranking model 124 may use the scores to rank (or re-rank) the entity identifiers 410 using a second ranking algorithm. Once the entity identifiers 410 are ranked (or re-ranked), a selector 438 selects an entity identifier 410 from the set of entity identifiers 410. The entity identifier 410 is passed to the recommendation model 126 for generation of a recommendation 148 for the entity identifier 440. In some case, the recommendation model 126 may use an explainability layer 406 to assist in generating the recommendation 148.

The optimization layer 404 provides supporting information including whether each entity identifier 410 is associated with an account that should be recommended due to the objectives 304 (e.g., monetization or engagement estimates). Specifically, the optimization layer 404 is responsible for taking constraints into consideration, balancing the importance of all aspects and providing the recommended ranking of accounts per sales rep R(A, S) as shown in Equation (3).

$$R ( A , S ) = f ( {Δ}_{monetization} , {Δ}_{engagement} , Objective 1 , Objective 2 , W ) \qquad EQUATION ( 3 )$$

In Equation (3), W represents the rest of the business constraint and preferences.

Within the optimization layer 404, there are a set of rules 434 comprising two different types of rules, namely hard rules and soft rules. A hard rule library comprises hard rules that are checked against requirements (e.g., must-meet criteria) for recommendations 148 that is collected from business or product partners. Examples of hard rules may include a rate limit (e.g., each account can only be recommended once every 2 weeks), an outreach frequency (e.g., each account has to be outreached at least once per 90 days), a time value (e.g., time to renewal such as 90 days before renewal), a monetization threshold value, an engagement threshold value (e.g., >=10% within a cohort), and other requirements. A soft rule library comprises soft rules that are checked against preferences (e.g., optional criteria). An example of a soft rule is for accounts closer to a renewal date (e.g., within X number of days), monetization should be considered a more important factor, otherwise engagement is given priority. The optimization algorithm 428 and/or ranking model 124 uses the rules 434 to rank all incoming accounts (e.g., accounts associated with an entity as identified by an entity identifier) within each sales representatives' book of business based on the hard rules and/or soft rules. Once the ranked account list is generated, this layer will provide supporting information including whether each account should be recommended due to monetization or engagement estimates.

In some embodiments, the optimization algorithm 428 is implemented as mixed-integer programming logic, code, or instructions. In Mixed Integer Programming (MIP), the aim is to find the optimal values for a set of variables that minimize or maximize a particular objective function 430, subject to a set of constraints 432. An objective function 430 is a mathematical expression that defines the goal of an optimization problem. It quantifies what needs to be minimized or maximized, such as cost, profit, efficiency, time, or resource utilization. The objective function 430 takes the decision variables of the problem as inputs and produces a single numerical output that reflects the “quality” or “desirability” of any given solution. In the context of optimization, the objective function 430 provides a criterion for comparing different feasible solutions. By optimizing this function, either finding its minimum or maximum value, under the given constraints 432, the optimization algorithm 428 determines an optimal solution according to the specified objective 304 (e.g., goal) of the problem. A constraint 432 comprises equations or inequalities that restrict the values the variables can take (e.g., resource limitations, logical conditions, etc.). In MIP, both the objective function 430 and constraints 432 are linear. What sets MIP apart is that some of these variables are restricted to integer values, while others can be continuous (real numbers). This combination allows MIP to model a wide range of real-world problems that involve both discrete decisions and continuous quantities.

A recommendation model 126 may then generate one or more recommendations 148 for one or more entity identifiers 146 associated with accounts that need action to further the objectives 304. The recommendation model 126 may generate the recommendations 148 using the explainability layer 406. The explainability layer 406 may comprise a set of templates 442 (e.g., for a customer, product, service, action, touchpoint, etc.). The recommendation model 126 may select a template 442 from the set of templates 442 suitable for the entity identifier 410. The recommendation model 126 then generates the recommendation 148 to recommend taking some form of action for the entity identifier 410 using the selected template 442.

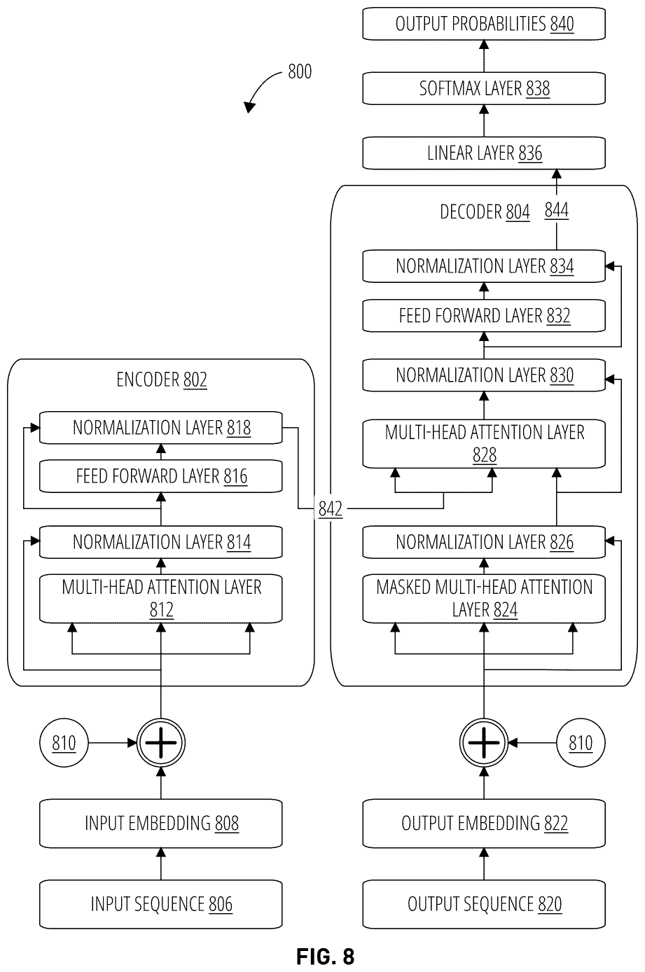

In some embodiments, the explainability layer 406 may comprise a generative artificial intelligence (GAI) model like generative AI model 444 (e.g., a large language model). Generative AI models like the generative pre-trained transformer (GPT) series utilize deep learning architectures to produce human-like text based on input prompts. These models are based on a transformer architecture, which employs self-attention mechanisms to process input data. By training on extensive text corpora, GPT models learn statistical patterns in language, enabling them to predict subsequent words in a sentence. For instance, given the prompt “The future of technology is”, the model might generate “shaped by advances in artificial intelligence and quantum computing.” The transformer architecture comprises encoder and decoder layers. GPT models typically use only the decoder stack with masked self-attention. This masking ensures that the model predicts a word based only on the preceding context, not future tokens. The self-attention mechanism calculates attention weights using query, key, and value vectors derived from the input embeddings, allowing the model to focus on relevant parts of the input sequence. Positional encodings are added to the input embeddings to retain the order of words. Training involves minimizing the cross-entropy loss between the model's predictions and the actual next words across the training dataset. Engineers can fine-tune these pre-trained models on domain-specific data to generate tailored content, such as code snippets, legal language, or medical reports. An example of a generative AI model 444 is described in more detail with reference to FIG. 8.

The recommendation 148 for the target entity 302, as identified by the entity identifier 440, is sent to a target application 446 of a client device 104 for a producing entity 108. The recommendation 148 is designed to recommend an action to take for the target entity 302, such as activities for improving sales related to productivity and providing accurate and actionable insights. The producing entity 108 may have one or more end users that use the recommendation 148 to take action for a target entity 302. The end users may be in sales operations, sales representatives, account representatives, decision makers, finance representatives, and other customer facing representatives. The recommendations 148 may be used for scenario planning, territory planning, account segmentation, quota setting, lead routing, sales outreach, contact interaction, content items, messages, and so forth. The recommendation 148 may include an entity identifier 146 and a notification 144.

The explainability layer 406 enhances a trust and/or confidence value to the logic diagram 300 by providing natural language expressions (e.g., human-readable explanations) for the recommendations 148 it generates. It takes the features 408 and output from the prediction layer 402 and/or optimization layer 404 and it generates explanations or comments via template 442 and/or the generative AI model 444, such as global feature importance, instance level feature importance, and/or a time series summary. For global feature importance, the explainability layer 406 leverages the feature importance calculated during the model training process (e.g., decreased impurity for tree based models). It gives an insight into what features 408, on average, drive the recommendations 148. In tree-based machine learning models, such as decision trees or ensembles like random forests and gradient-boosted decision trees, “decreased impurity” is tied to how the model chooses splits when building the tree. The explainability layer 406 can explain the splits and their impact on the recommendation 148. The generation process makes it a good substitute for instance level feature importance. For instance level feature importance, the explainability layer 406 may implement or call a consistency local interpretable model-agnostic explainer (C-LIME) for time-series predictions to generate the instance level importance. C-LIME is an explanation technique that explains the prediction of any classifier in an interpretable and faithful manner by learning an interpretable model locally around the prediction. For engagement metrics, not only would it be valuable to learn about a customer's engagement for the next month, but it may also be valuable information to know the trend, such as whether a customer's engagement is on the rise or experiencing a decline. The summary could be as simple as “The recruiter seat engagement drops x % compared to the last 4 month average.” Embodiments are not limited to these examples.

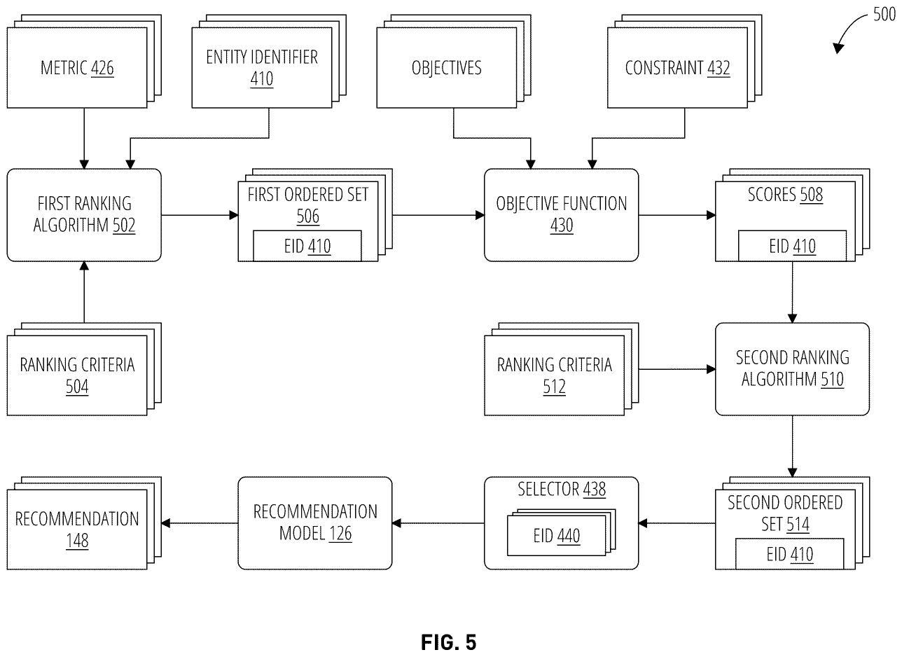

FIG. 5 illustrates a logic diagram 500. The logic diagram 500 is an example of operations for the ML architecture 400.

As depicted in FIG. 5, the logic diagram 500 illustrates the ranking model 124 implementing a first ranking algorithm 502. The first ranking algorithm 502 receives as input the metrics 426 and entity identifiers 410 from the prediction layer 402. The first ranking algorithm 502 ranks the entity identifiers 410 based on the metrics 426 and a set of ranking criteria 504. The first ranking algorithm 502 outputs a first ordered set 506 of entity identifiers 410.

The optimization algorithm 428 implements the objective function 430 using MIP. The objective function 430 receives the first ordered set 506 and optimizes the first ordered set 506 in accordance with a set of objectives 304 and a set of constraints 432. The output of the objective function 430 is a set of scores 508 corresponding to the entity identifiers 410 of the first ordered set 506. The scores 508 for the entity identifiers 410 are input to a second ranking algorithm 510. The second ranking algorithm 510 ranks the entity identifiers 410 based on the scores 508 and a set of ranking criteria 512. The ranking criteria 512 may be the same as, or different from, the ranking criteria 504. The second ranking algorithm 510 outputs a second ordered set 514 of entity identifiers 410.

There are numerous ways to rank a set of scores depending on the underlying objectives and constraints. The ranking criteria 504 and/or ranking criteria 512 are parameters that control how the first ordered set 506 and second ordered set 514 are actually ranked. For example, one ranking technique is to order them by a raw value, either descending if higher is better or ascending if a lower score indicates a more favorable outcome. In cases where scores come from different scales or distributions, normalization or standardization can help, such as converting each score to a z-score or rescaling values to a 0-1 range, ensuring that comparisons are fair. For more complex scenarios involving multiple metrics, creating a composite score by assigning different weights to each metric, or applying models like linear or logistic regression, can yield an integrated ranking reflecting various priorities. Some approaches focus on comparing each score against a target or baseline, ranking based on closeness to the ideal value or improvement over time. Additionally, multi-dimensional ranking criteria, like Pareto efficiency, consider whether any score dominates others across all metrics, while ratio-based approaches weigh performance against associated costs or resources. Lastly, robust ranking can account for uncertainty by incorporating confidence intervals or error estimates, ensuring that the final ordering balances both performance and reliability.

A selector 438 receives as input the second ordered set 514 of entity identifiers 410. The selector 438 identifies and selects one or more of entity identifiers 440 from the set of entity identifiers 410 of the second ordered set 514. For example, the selector 438 may select a top K % of entity identifiers 410 or a top M number of entity identifiers, where K and M represent any positive integer. In some embodiments, the selector 438 is designed to identify and select a single entity identifier 410 from the second ordered set 514 of entity identifiers 410.

The recommendation model 126 receives the entity identifier 440, where the entity identifier 440 is associated with a target entity 302. The recommendation model 126 retrieves a set of information associated with the target entity 302, such as entity data 134 and/or activity data 136. The recommendation model 126 uses this information to personalize or customize the recommendation 148 to the target entity 302 identified by the entity identifier 440. The activity data 136 for the target entity 302 may comprise different types of data associated with the target entity 302, such as time information (e.g., a number of days to renewing a subscription to a product or service), financial information (e.g., an amount of annual accrued revenue), engagement information (e.g., login activity to connection network platform 112, page views, monthly searches, last touchpoint, etc.), statistical information (e.g., increase or decrease in monthly sales revenue from a customer), and other types of information. The recommendation model 126 generates a recommendation 148 for the target entity 302 using the entity data 134, activity data 136, and one or more template 442. In some embodiments, the recommendation model 126 may generate the recommendation 148 using this information and a generative AI model 444. In some embodiments, the recommendation model 126 may generate the recommendation 148 using this information and a combination of one or more templates and the generative AI model 444. Embodiments are not limited in this context.

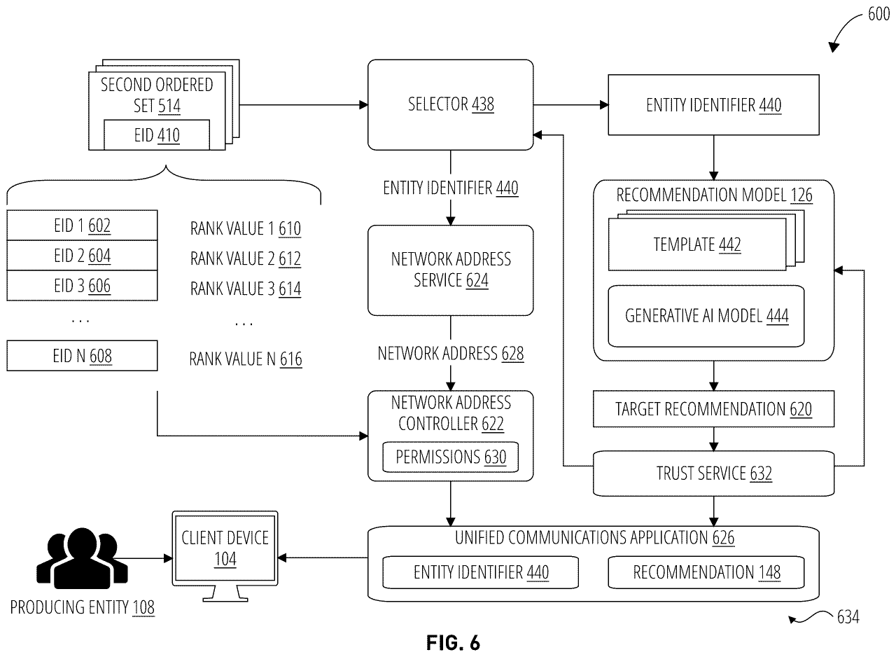

FIG. 6 illustrates a logic diagram 600. The logic diagram 600 is another example of operations for the ML architecture 400.

As depicted in FIG. 6, the logic diagram 600 illustrates a second ordered set 514 of entity identifiers 410. For example, the second ordered set 514 may comprise an entity ID 1 602, entity ID 2 604, entity ID 3 606, and entity ID N 608 having a corresponding rank of rank value 1 610, rank value 2 612, rank value 3 614, and rank value N 616, respectively, where N represents any positive integer.

The selector 438 may receive as input the second ordered set 514, and it may select an entity identifier 440 associated with a target entity 302 from the second ordered set 514. The selector 438 outputs the entity identifier 440 to a network address service 624 and a recommendation model 126.

The network address service 624 lookups a network address 628 associated with a client device 104 associated with the entity identifier 440. The network address service 624 may use a lookup table in the data store 132, use a domain name service (DNS), use a mail service, retrieve from a system cache, or use some other technique. The network address service 624 then outputs the network address 628 to a network address controller 622.

The network address controller 622 sets one or more permissions 630 for the network address 628. For example, the network address controller 622 may grant permission or deny permission to send a message to the network address 628. For example, the network address controller 622 may grant permission when the network address 628 is part of a white list, and it may deny permission when the network address 628 is part of a black list. The network address controller 622 may also set one or more permissions 630 for the entity identifiers 410 of the second ordered set 514. For example, the network address controller 622 may grant permission when an entity identifier 410 or entity identifier 440 is part of a white list, and it may deny permission when an entity identifier 410 is part of a black list. In some embodiments, the network address controller 622 may be configured to set permissions 630 to automatically grant permission to send a message to the network address 628 of the entity identifier 440 and deny permission to send a message to the rest of the entity identifiers 410. This may prevent the connection network platform 112 from accidentally sending messages to the other entity identifiers 410 when not intended (e.g., as spam). These are merely a few examples of when the network address controller 622 may set permissions 630, and others exist as well. For example, the network address controller 622 may set permissions based on a set of security policies implemented by the security application 116 of the connection network platform 112. Embodiments are not limited to these examples.

The recommendation model 126 receives the entity identifier 440 as input. The recommendation model 126 retrieves entity data 134 and/or activity data 136 associated with the entity identifier 440 and/or producing entity 108. The recommendation model 126 then generates a recommendation 148 for the producing entity 108 about the target entity 302. In some embodiments, the recommendation model 126 may generate the recommendation 148 by filling in fields of a template 442 using the entity data 134 and/or activity data 136. In some embodiments, the recommendation model 126 may generate the recommendation 148 using the generative AI model 444. For example, the recommendation model 126 may use prompt engineering techniques to generate an input prompt for the generative AI model 444. The generative AI model 444 may receive as input the input prompt, generate the recommendation based on the input prompt, and output a target recommendation 620.

A trust service 632 may receive as input the target recommendation 620. The trust service 632 is a content moderation tool or trust and safety platform that reviews content for inappropriate language. The trust service 632 is designed to ensure that the content from the generative AI model 444 adheres to community standards, legal requirements, or organizational policies. The trust service 632 may analyze the target recommendation 620 using a set of trust policies to ensure that the target recommendation 620 does not violate any of the trust policies. For example, the trust policies may comprise policies to restrict profanity, hate speech, political language, discriminatory language, criminal language, hallucinatory language, aggressive language, imperative language, and other types of inappropriate language. The trust service 632 may validate the target recommendation 620 as suitable for the recommendation 148, send feedback to the generative AI model 444 to regenerate the target recommendation 620, adjust the language of the recommendation 148, or simply deny the target recommendation 620. When denying the target recommendation 620, the selector 438 may select a new entity identifier 440 from the entity identifiers 410 of the second ordered set 514, and generate a target recommendation 620 for the new entity identifier 440.

A router 634 may perform message routing services using messaging infrastructure to facilitate delivery of the recommendation 148 across a set of messaging modalities, messaging channels, and target applications 446. In some cases, the router 634 may be designed to perform context based routing of the recommendation 148. For example, the router 634 may be implemented using a unified communications application 626 operative to receive as input the entity identifier 440 (and network address 628) for the target entity 302 from the network address controller 622 and the recommendation 148 from the trust service 632. The unified communications application 626 sends the recommendation 148 to the network address 628 of the client device 104 associated with the producing entity 108 for review by the producing entity 108. The unified communications application 626 seamlessly integrates multiple communication modalities into a single, user-friendly interface, such as instant messaging, Voice over Internet Protocol (VOIP) calls, video conferencing, and email. It leverages advanced technologies like Session Initiation Protocol (SIP) for initiating interactive communication sessions and supports Web Real-Time Communication (WebRTC) for high-quality audio and video streams directly in a browser. The unified communications application 626 ensures secure communication through end-to-end encryption and complies with industry standards like Transport Layer Security (TLS) for data protection. Moreover, the unified communications application 626 features intelligent routing and presence information, allowing visibility into real-time availability of connections to allow selection of the most effective communication channel. This allows the producing entity 108 to immediately engage with the target entity 302 via the selected communication channel. It also supports integrations with various productivity tools and APIs, enabling seamless workflow management and data synchronization across platforms. With support for high-definition codecs and adaptive bandwidth management, it delivers high-fidelity audio and video experiences, even in low-bandwidth conditions.

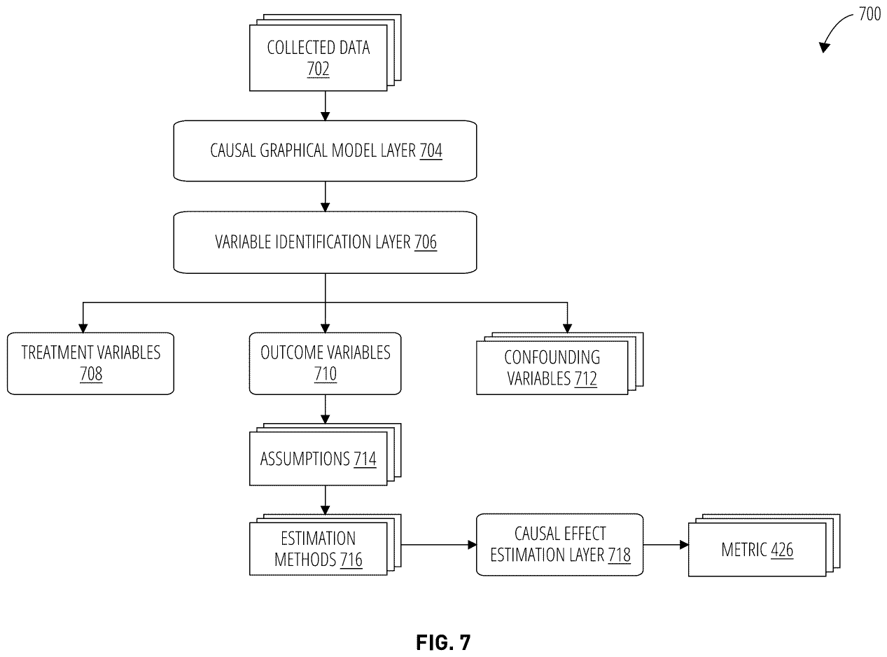

FIG. 7 illustrates a logic diagram 700. The logic diagram 700 is an example of operations for some or all of the ML architecture 400. For example, the logic diagram 700 is an example of a causal model 422 for the prediction layer 402. Specifically, the logic diagram 700 is an example of components and workflow for a causal model 422. Embodiments are not limited to this example.

Causal models in machine learning are designed to uncover and quantify cause-and-effect relationships between variables, moving beyond mere statistical associations. It starts with data collection and moves through model construction, variable identification, assumption specification, estimation, and finally to decision-making based on the causal effects estimated. The causal model 422 applies causal inference techniques to obtain valid and actionable insights.

As depicted in FIG. 7, the logic diagram 700 comprises a set of collected data 702. The collected data 702 may comprise data collected from data sources such as historical data, observational studies, controlled experiments, and/or other domain knowledge. The collected data 702 is used in the construction of the causal graphical model. The nature of the data used, whether observational or experimental, potentially affects the causal analysis. Observational data require careful adjustment for confounding because treatment assignment is not controlled and may be related to both the treatment and the outcome. Experimental data from randomized trials have treatment assignments that are independent of confounders, simplifying the causal inference process.

The logic diagram 700 comprises a causal graphical model layer 704. Using domain knowledge, the causal graphical model layer 704 implements a causal graph that is constructed to represent assumptions about the causal relationships between variables. Causal relationships among these variables are often represented using causal graphical models, specifically Directed Acyclic Graphs (DAGs). In a DAG, nodes represent variables, and directed edges (arrows) indicate causal influence from one variable to another. These graphs are acyclic, meaning they do not contain feedback loops, and they help identify confounding structures, permissible adjustment sets, and pathways for estimating causal effects.

The logic diagram 700 comprises a variable identification layer 706. The variable identification layer 706 uses the causal graph to identify treatment variables 708, outcome variables 710, and confounding variables 712. The treatment variables 708 refer to a set of factors or interventions that are actively manipulated or analyzed to observe their effects on outcomes. The treatment variables 708 represent the intervention or action of interest (sometimes denoted as TT or AA) whose effect on the outcome is measured. An intervention is an action or manipulation introduced to a system or environment with a goal of observing its effects on specific outcomes, such as increasing a dosage of a drug in a medical trial, implementing a new teaching method with new study materials, randomized control trials in clinical research, or hypothetical scenarios such as reducing a price of a product by 20%. A model designer may change the treatment variables 708 in experiments or simulations, such as offering a discount, changing an advertisement, or introducing a drug. The outcome variables 710 are variables that are affected by the treatment variables 708 and are of primary interest. The outcome variables 710 (sometimes denoted as YY) are the response affected by the treatment variables 708. The treatment variables 708 and the outcome variables 710 may vary according to different domains, such as healthcare, marketing, education, economics, or technology. For example, in a marketing domain, a treatment variable 708 may be exposure to an advertisement or promotion, and an outcome variable 710 may be click-through rates or purchase likelihood. In a technology domain, a treatment variable 708 may be deployment of a new recommendation algorithm, and an outcome variable 710 may be user engagement metrics (e.g., time spent, conversion rate, etc.). The confounding variables 712 are variables that affect both the treatment variables 708 and the outcome variables 710. The confounding variables 712 (or confounders) are variables (sometimes denoted as XX) that influence both the treatment and the outcome, potentially introducing bias if not properly controlled. The variable identification layer 706 identify these and other types of variables, at least in part, based on the causal graph.

In addition, the variable identification layer 706 may identify other variables, such as mediators, moderators and instrumental variables. Mediators (sometimes denoted as MM) that lie on the causal path between the treatment and the outcome explain the mechanism through which the treatment affects the outcome. Moderators (sometimes denoted as ZZ) modify the strength or direction of the causal effect, interacting with the treatment to produce different outcomes. Instrumental variables are special variables that affect the treatment but have no direct effect on the outcome except through the treatment, helping to address unmeasured confounding.

The logic diagram 700 comprises a set of assumptions 714. The assumptions 714 guide selection of appropriate estimation methods 716. Examples of assumptions 714 include no unmeasured confounding, consistency, exchangeability, and other assumptions 714. Assumptions play a role in ensuring valid causal inferences. A model designer defines the assumptions 714 for a given causal model 422, which can change based on research, experiments, or collected data. The no unmeasured confounding assumption, also known as ignorability or exchangeability, posits that all variables confounding the treatment-outcome relationship are measured and included in the model. Formally, this is expressed as (Y(0), Y(1)) LEL TIX, indicating that the potential outcomes are independent of treatment assignment given the confounders. The Stable Unit Treatment Value Assumption (SUTVA) asserts that there is no interference between units (a unit treatment does not affect another outcome) and that treatments are consistently applied. Consistency assumes that the observed outcome equals the potential outcome under the treatment actually received. Positivity, or overlap, requires that every unit has a positive probability of receiving each level of the treatment, ensuring comparability across treatment groups.

The logic diagram 700 comprises a set of estimation methods 716. Methods like Propensity Score Matching, Regression Adjustment, Instrumental Variables, etc., are employed to estimate the causal effect. The chosen methods are applied to the data to adjust for confounding variables 712 and estimate the effect. Various estimation methods are employed to quantify causal effects. Structural Equation Models (SEMs) use mathematical equations to represent causal relationships, capturing both direct and indirect effects and accommodating latent variables. Propensity score methods involve estimating the probability of treatment assignment given covariates to adjust for confounding. The propensity score e(X)=P(T=1|X) is used in matching, stratification, weighting, or covariate adjustment to balance treatment groups. Inverse Probability Weighting (IPW) assigns weights to each unit based on the inverse of the probability of receiving the treatment they actually received, creating a pseudo-population where covariates are independent of treatment assignment.

Doubly robust estimators combine propensity score weighting with outcome regression, providing consistent estimates if either the treatment model or the outcome model is correctly specified. For example, the doubly robust estimator for the average treatment effect (ATE) incorporates both models to mitigate bias. Instrumental variable methods, such as Two-Stage Least Squares (2SLS), address unmeasured confounding by using instruments that affect the treatment but not the outcome directly. Matching methods pair units in treatment and control groups with similar covariate values to mimic randomized experiments. Regression adjustment involves modeling the outcome as a function of the treatment and covariates to adjust for confounding effects.

Advanced causal machine learning methods extend traditional algorithms to estimate heterogeneous treatment effects and capture complex relationships. Causal forests, for instance, build on random forests to estimate treatment effects that vary across individuals. Meta-learners like the T-learner, S-learner, and X-learner combine base learners to estimate treatment effects more effectively. Targeted Maximum Likelihood Estimation (TMLE) integrates machine learning with statistical inference to provide robust causal parameter estimates.

The concept of counterfactuals and the potential outcomes framework is central to causal inference. Each unit has potential outcomes under each treatment level (e.g., Yᵢ(1) and Yᵢ(0)), but only one of these is observed for each unit. The fundamental problem of causal inference is that both potential outcomes cannot be observed simultaneously. This framework allows a definition of causal effects like the Average Treatment Effect (ATE) as ATE=E[Y(1)−Y(0)].

Identification strategies are used for determining causal effects from data under specific assumptions. Randomized Controlled Trials (RCTs) are the gold standard, as randomization ensures no confounding. When randomization is not feasible, methods like natural experiments exploit external events or instruments that assign treatment quasi-randomly. Difference-in-Differences (DiD) compares changes over time between treated and control groups to infer causal effects. Regression Discontinuity Design (RDD) uses a cutoff point in an assignment variable to identify causal effects around that threshold.

Model evaluation and validation involve assessing the credibility and robustness of the causal model and its estimates. Sensitivity analysis tests how results change with potential violations of assumptions, such as unmeasured confounding. Placebo tests apply the causal inference methods where no effect is expected to check for spurious findings. Checking the balance of covariates across treatment groups after adjustment ensures that the methods have effectively controlled for confounding.

The logic diagram 700 comprises a causal effect estimation layer 718. The causal effect estimation layer 718 estimates a causal effect of the treatment variables 708 on the outcome variables 710 using one or more estimation methods 716. The causal effect estimation layer 718 outputs a set of metrics 426, which are values representing estimated causal effects used to make informed decisions, implement policies, or plan interventions.

With respect to objectives 304 such as monetization potential and customer engagement, the causal model 422 may estimate an incremental value from sales engagement on both monetization effort and engagement, using Equation (1) and Equation (2) as previously described. In Equation (1) and Equation (2), X is the customer feature vector. The outputs from this layer are values Δ_{monetization} and Δ_{engagement}. For example, the Δ_{monetization} may be a prediction of an objective 304 for a monetization of revenue from a customer and/or a value representing a prediction of sales engagements impact on upsell or churn. The Δ_{engagement} may be a prediction of an objective 304 for an engagement of a customer and an engagement index for a defined time period (e.g., days, weeks, months, etc.). The predictions may be stored as account level monetization predictions and account level engagement predictions in the data store 132.

FIG. 8 illustrates a transformer model 800. The transformer model 800 is an example of a transformer architecture suitable for implementation as the generative AI model 444. In particular, the transformer model 800 is an example of a transformer architecture suitable for GPT, such as a version of ChatGPT. ChatGPT is trained on massive amounts of data, allowing it to generate text and respond to various prompts with human-like precision and accuracy. Embodiments are not limited to transformers. It is worthy to note that the transformer model 800 and/or generative AI model 444 may be executed on local servers or remote servers accessed via a set of APIs. Embodiments are not limited in this context.

As depicted in FIG. 8, the transformer model 800 comprises an encoder 802 and a decoder 804. The encoder 802 receives as input an input sequence 806, which is converted to an input embedding 808. A positional encoding 810 is added to the input embedding 808. The input embedding 808 with positional encoding 810 is input to the encoder 802. The encoder 802 comprises a multi-head attention layer 812, a normalization layer 814, a feed forward layer 816, and a normalization layer 818. The encoder 802 outputs an encoder output 842 to the decoder 804. The decoder 804 receives as input an output sequence 820, which is converted to an output embedding 822. A positional encoding 810 is added to the output embedding 822. The output embedding 822 with positional encoding 810 is input to the decoder 804. The decoder 804 comprises a masked multi-head attention layer 824, a normalization layer 826, a multi-head attention layer 828, a normalization layer 830, a feed forward layer 832, and a normalization layer 834.

Specifically, the encoder 802 is a neural sequence transduction model comprising an encoder 802 and a decoder 804. The encoder 802 receives an input sequence 806 and it translates the input sequence 806 into a lower-dimensional space. The encoder 802 maps an input sequence of symbol representations (x₁, . . . , xₙ) to a sequence of continuous representations z=(z₁, . . . , Zₙ). Given z, the decoder 804 then generates an output sequence (y₁, . . . , yₘ) of symbols one element at a time. At each step, the model is auto-regressive, consuming the previously generated symbols as additional input when generating the next. The decoder 804 translates the lower-dimensional data provided by the encoder 802 back to the original data format. Both the encoder 802 and the decoder 804 share three main types of layers, including a positional encoding layer, self-attention layer, and feedforward layer.

The encoder 802 transforms natural language input into numerical vectors. The encoder 802 receives an input sequence 806. The input sequence is a sequence of tokens (e.g., words or sub-words) that represent the text input. An input encoding layer of the encoder 802 converts the input sequence 806 into an input embedding 808. An input embedding 808 is a numerical representation of concepts converted to number sequences. The input embedding 808 is an NLP technique that represents words with vectors in such a way that once represented in a vectorial space, the mathematical distance between vectors is representative of the similarity among words they represent. For example, the content delivery application 122 may incorporate input embeddings to personalize, recommend, and search content. The input embedding 808 may comprise a matrix of vectors, where each vector represents a token in the sequence. The input embedding layer maps each token to a high-dimensional vector that captures the semantic meaning of the token.

Positional encoding 810 is a fixed, learned vector that represents a position of a word in the input sequence. It is added to the input embedding 808 so that the final representation of a word includes both its meaning and its position. Positional encoding is a technique used in transformer architectures, such as those employed by ChatGPT, to provide information about the relative positions of tokens in the input sequence. Since transformers do not inherently recognize the order of tokens due to their attention mechanism, positional encoding is crucial for enabling the model to consider sequence structure. To capture the order of the tokens in the input sequence, a positional encoding is added to the input embedding 808. The positional encoding is a vector that represents the position of each token in the sequence.

The encoder 802 includes multiple self-attention layers. The self-attention layers are responsible for determining the importance of each input token in generating the output. The self-attention layer allows the model to compute relationships between different parts of the input sequence 806. In order to obtain a self-attention vector for a sentence, the self-attention layer uses query, key, and value matrices. These matrices are used to calculate attention scores between the elements in the input sequence and are three weight matrices that are learned during the training process. In the query, key, and value computations, the input vectors are transformed into three different representations using linear transformations. In an attention computation operation, the model computes a weighted sum of the values, where the weights are based on the similarity between the query and key representations. The weighted sum represents the output of the self-attention mechanism for each position in the sequence.

The encoder 802 uses a multi-head attention layer 812. The multi-head attention layer 812 uses multiple self-attention layers operating in parallel on different parts of the input data, producing multiple representations. The multi-head attention layer 812 allows the model to focus on different parts of the input sequence and compute relationships between them in parallel. In each head, the query, key, and value computations are performed with different linear transformations, and the outputs are concatenated and transformed into a new representation. The output of the multi-head self-attention mechanism is fed into a feed forward layer 816.

The feed forward layer 816 comprises a series of fully connected layers and activation functions. The feed forward layer 816 transforms the output of the multi-head attention layer 812 into a suitable representation for the final output. The feed forward layer 816 is a fully connected layer, also known as a dense layer, where every neuron in the layer is connected to every neuron in the preceding layer. An activation function is a non-linear function that is applied to the output of the fully connected layer. The activation function introduces non-linearity into the output of a neuron, which allows the network to learn complex patterns and relationships in the input data. An example of an activation function is a rectified linear unit (ReLu). The output of the feed forward layer 816 is used as input to the next layer in the encoder 802.

The encoder 802 may also comprise a number of normalization layers, such as a normalization layer 814 and a normalization layer 818. The activations in each layer of the transformer architecture are normalized using layer normalization, which helps stabilize the training process and prevent the model from overfitting. A residual connection followed by layer normalization helps to stabilize the training process and make the model easier to train. The output of the normalization layer 818 is the final output from the encoder 802 and it is a vector representation of the input sequence 806. The final output from the normalization layer 818 is used as input to the multi-head attention layer 828 of the decoder 804.

The decoder 804 decodes the input sequence 806 to the original data format. Similar to the encoder 802, the decoder 804 shares the core elements of positional encoding, self-attention, and feedforward layers. As depicted in transformer model 800, the decoder 804 comprises a masked multi-head attention layer 824, a normalization layer 826, a multi-head attention layer 828, a normalization layer 830, a feed forward layer 832, and a normalization layer 834. The decoder 804 outputs a decoder output 844 to a linear layer 836. The linear layer 836 is a feedforward network that adapts the dimension of the input to the dimension of the output. The output of the linear layer 836 feeds into a softmax layer 838. The softmax layer 838 transforms the input into a vector of probabilities. The output of the softmax layer 838 is a set of an output probabilities 840 for the transformer model 800. The transformer model 800 then picks the word corresponding to the highest probability and uses it as a best output of the model.

In some embodiments, the generative AI model 444 may be implemented using the transformer model 800. Referring again to FIG. 4, once the selector 438 selects an entity identifier 440, it forwards the entity identifier 440 to the recommendation model 126. The recommendation model 126 generates a recommendation 148 for the entity identifier 440. This can be accomplished in at least two ways. First, the recommendation model 126 retrieves a template 442 suitable for the entity identifier 440. For example, if the entity identifier 440 is for a target entity 302 in a cybersecurity industry, the recommendation model 126 retrieves a template 442 suitable for the cybersecurity industry. The template 442 may comprise a pre-generated form with multimedia information and fields for entering information. The recommendation model 126 scans the template 442, and enters data into the fields (e.g., entity data, activity data, statistical data, etc.). The completed template 442 serves as the recommendation 148. Additionally, or alternatively, the recommendation model 126 generates a prompt for the generative AI model 444. The prompt may include instructions for generating the recommendation 148 and/or a set of data (e.g., entity data, activity data, statistical data, etc.) using various prompt engineering techniques. The generative AI model 444 receives the prompt as input, generates the recommendation 148, and sends it to the recommendation model 126.

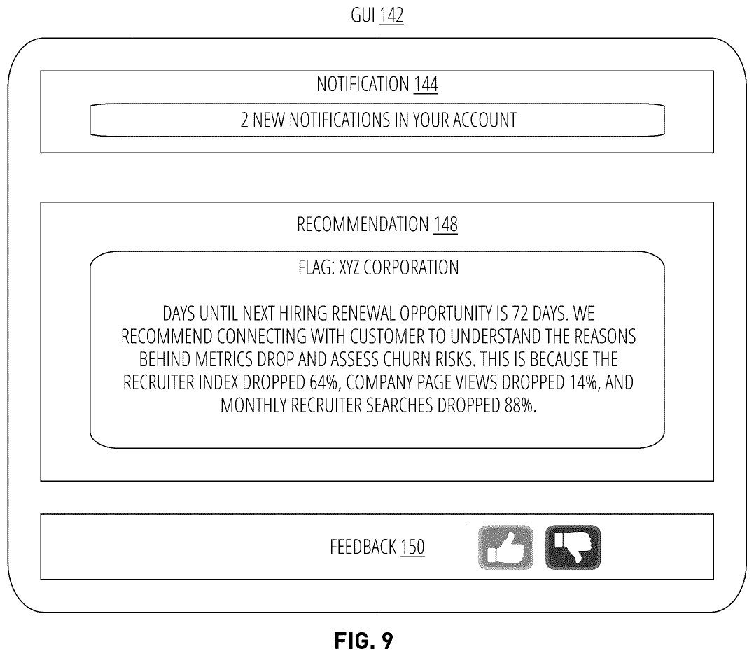

FIG. 9 illustrates an example of GUI 142 presented on a client device 104 of a producing entity 108. Embodiments are not limited to this example.

As depicted in FIG. 9, the GUI 142 provides an example of a notification 144 and a recommendation 148. In this example, assume the selector 438 selects an entity identifier 440 associated with an entity “XYZ Corporation.” The recommendation model 126 may generate a recommendation 148 for the “XYZ Corporation”, and the router 634 may send the recommendation 148 to a client device 104 of a producing entity 108. The GUI 142 is presented on an electronic display of the client device 104. For example, a target application 446 may comprise a CRM that generates the GUI 142 as an in-app notification, an email message, a text message, or as part of a content feed.

The GUI 142 may comprise various GUI elements to present multimedia information. For example, the GUI 142 may comprise a GUI element to present the notification 144 and a GUI element to present the recommendation 148. The recommendation 148 may include multimedia content, including a textual description written in a natural human language. For example, the recommendation 148 may recite “Flag: XYZ Corporation, Days until next hiring renewal opportunity is 72 days. We recommend connecting with customer to understand the reasons behind metrics drop and assess churn risks. This is because the recruiter index dropped 64%, company page views dropped 14%, and monthly recruiter searches dropped 88%. The GUI 142 may present multiple notifications and recommendations 148 for various target entities 302, such as in an order ranked by the ranking model 124.

In some cases the GUI 142 may present a GUI element for feedback 150. The feedback 150 may comprise a button for feedback tracking, such as tracking user interaction with the GUI 142. The feedback 150 may be implemented using real time or near real time latency leveraging a tracking infrastructure for the connection network platform 112 of the connection network system 100. The feedback 150 may be explicit feedback (e.g., a like button, a dislike button, a sharing button, etc.) or implicit feedback (e.g., a view, an impression, proximity detection, etc.). The feedback 150 is added to the features 408 for use as part of the next input vector 412 for the prediction layer 402, optimization layer 404, and explainability layer 406 of the ML architecture 400.

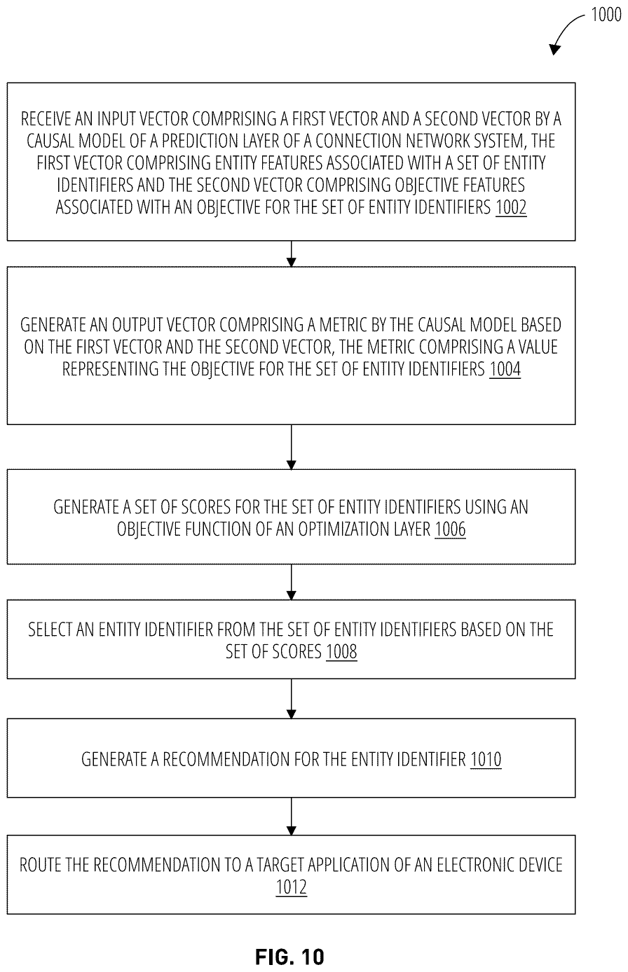

FIG. 10 illustrates an embodiment of a logic flow 1000. The logic flow 1000 may be representative of some or all of the operations executed by one or more embodiments described herein. For example, the logic flow 1000 may include some or all of the operations performed by devices or entities within the connection network platform 112 of the connection network system 100, such as the server device 102 and/or the client device 104. More particularly, the logic flow 1000 illustrates an example where the server device 102 performs a set of training and/or inferencing operations of a ML model such as an ML model 230 to support one or more network services 114 provided by the connection network platform 112 of the connection network system 100. For example, the logic flow 1000 may be performed by the server device 102 and/or the client device 104 of the connection network system 100, system 200, logic diagram 300, ML architecture 400, logic diagram 500, logic diagram 600, logic diagram 700, transformer model 800, apparatus 1200, and/or logic diagram 1300.

As depicted in logic flow 1000, at block 1002 the logic flow 1000 comprises receiving an input vector comprising a first vector and a second vector by a causal model of a prediction layer of a connection network system, the first vector comprising entity features associated with a set of entity identifiers and the second vector comprising objective features associated with an objective for the set of entity identifiers. In logic flow 1000, at block 1004 the logic flow 1000 comprises generating an output vector comprising a metric by the causal model based on the first vector and the second vector, the metric comprising a value representing the objective for the set of entity identifiers. In logic flow 1000, at block 1006 the logic flow 1000 comprises generating a set of scores for the set of entity identifiers using an objective function of an optimization layer. In logic flow 1000, at block 1008 the logic flow 1000 comprises selecting an entity identifier from the set of entity identifiers based on the set of scores. In logic flow 1000, at block 1010 the logic flow 1000 comprises generating a recommendation for the entity identifier, and routing the recommendation to a target application of an electronic device. In logic flow 1000, at block 1012 the logic flow 1000 comprises routing the recommendation to a target application of an electronic device 1012.

By way of example, the insight manager application 128 may implement an ML architecture 400 to provide insights, such as recommendations 148, about target entities 302 for a producing entity 108. The prediction layer 402 of the ML architecture 400 receives an input vector 412 comprising a first vector 414 and a second vector 416 by a causal model 422 of a connection network system 100. The first vector 414 comprises entity features 418 associated with a set of entity identifiers 410 and the second vector 416 comprises objective features 420 associated with an objective 304 for the set of entity identifiers 410.

The causal model 422 receives the input vector 412, and it generates an output vector 424 comprising a metric 426 based on the first vector 414 and the second vector 416. The metric 426 comprises a value representing the objective 304 for the set of entity identifiers 410.

The optimization layer 404 receives the entity identifiers 410, and it generates a set of scores 436 for the set of entity identifiers 410 using an objective function 430 implemented by an optimization algorithm 428. For example, the optimization algorithm 428 may comprise or implement a linear programming algorithm, such as a mixed integer programming algorithm for an objective function 430 with a set of constraints 432.

A selector 438 receives the scores 436, and it selects an entity identifier 440 from the set of entity identifiers 410 based on the set of scores 436. The selector 438 passes the entity identifier 440 to a recommendation model 126. The recommendation model 126 generates a recommendation 148 for the entity identifier 440. For example, the recommendation 148 may comprise a recommendation for the producing entity 108 to perform an action for the entity identifier 440, such as call, send an email, message, or otherwise engage with the target entity 302 associated with the entity identifier 440. The recommendation 148 is passed to a router 634, and it routes the recommendation 148 to a target application 446 of an electronic device, such as a client device 104 of the producing entity 108.

In some embodiments, for example, the optimization algorithm 428 normalizes the raw data from the objective function 430 to normalize the value for the metric 426 to form a normalized value within a defined range of values (e.g., within a range of −100 to 100).

In some embodiments, for example, the optimization algorithm 428 receives a set of rules 434 associated with the objective 304. The optimization algorithm 428 generates the set of scores 436 for the set of entity identifiers 410 based on the metric 426 and the set of rules 434. The rules 434 may comprise hard rules, soft rules, or a combination of hard rules and soft rules. The rules 434 may comprise rules for a producing entity 108, a target entity 302, an objective 304, a constraint 432, ranking entities, selecting entities, time rules, revenue rules, activity rules, and so forth.

In some embodiments, for example, the recommendation model 126 may generate the recommendation 148 using components of an explainability layer 406, such as a template 442, a generative AI model 444, or a combination of a template 442 and a generative AI model 444. When the recommendation model 126 uses the generative AI model 444, the recommendation model 126 may generate an input prompt for the generative AI model 444 to control output of the generative AI model 444 using prompt engineering techniques.

In some embodiments, for example, the recommendation model 126 generates the recommendation 148 using multimedia information comprising text information in natural language expressions, graph information, image information, animation information, video information, or audio information.

In some embodiments, for example, the insight manager application 128 and/or connection intelligence application 130 may cause presentation of the recommendation 148 in a GUI 142 of the electronic device, such as a client device 104. The GUI 142 may receive an activation signal from a GUI element of the GUI, such as GUI element to provide feedback 150. For example, the producing entity 108 may select, click, hover, or otherwise engage with the GUI element to generate the activation signal. The activation signal may represent feedback 150, such as implicit feedback or explicit feedback, for the recommendation 148. For example, the implicit feedback may comprise a click or an impression associated with the recommendation and the explicit feedback may comprise a positive signal or a negative signal for the recommendation. The ML architecture 400 may store the feedback 150 as part of the features 408, and may update the first vector 414 or the second vector 416 of the input vector 412 for the prediction layer 402 to generate a new metric 426 based on the feedback 150 provided by the activation signal.

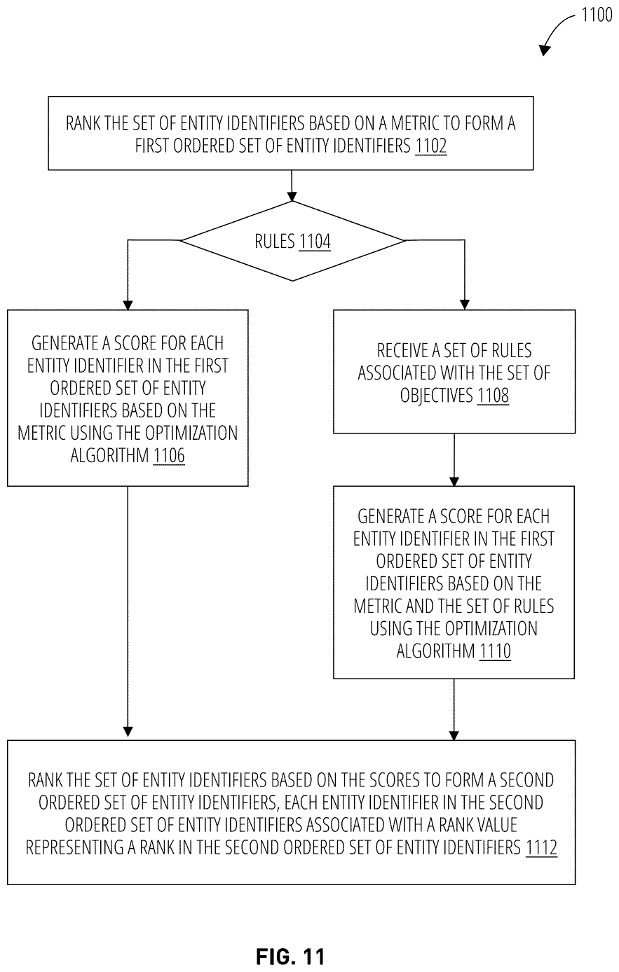

FIG. 11 illustrates an embodiment of a logic flow 1100. The logic flow 1100 may be representative of some or all of the operations executed by one or more embodiments described herein. For example, the logic flow 1100 may include some or all of the operations performed by devices or entities within the connection network platform 112 of the connection network system 100, such as the server device 102 and/or the client device 104. More particularly, the logic flow 1000 illustrates an example where the server device 102 performs a set of inferencing operations of a ML model such as a generative AI model to support one or more network services 114 provided by the connection network platform 112 of the connection network system 100. For example, the logic flow 1100 may be performed by the server device 102 and/or the client device 104 of the connection network system 100, system 200, logic diagram 300, ML architecture 400, logic diagram 500, logic diagram 600, logic diagram 700, transformer model 800, apparatus 1200, logic diagram 1300, and/or logic flow 1000.

As depicted in logic flow 1100, at block 1102 the logic flow 1100 includes ranking the set of entity identifiers based on a metric to form a first ordered set of entity identifiers. At decision block 1104, the logic flow 1100 determines whether there is a set of rules associated with a set of objectives for generation of the metric. If there are no rules at decision block 1104, at block 1106 the logic flow 1100 generates a score for each entity identifier in the first ordered set of entity identifiers based on the metric using the optimization algorithm. If there are rules at 1104, at block 1108 the logic flow 1100 receives a set of rules associated with the set of objectives 304. The logic flow 1100 generates a score for each entity identifier in the first ordered set of entity identifiers based on the metric and the set of rules using the optimization algorithm. At block 1112, the logic flow 1100 ranks the set of entity identifiers based on the scores to form a second ordered set of entity identifiers, each entity identifier in the second ordered set of entity identifiers associated with a rank value representing a rank in the second ordered set of entity identifiers.

By way of example, a ranking model 124 ranks the set of entity identifiers 410 based on the metric 426 and (optionally) a set of rules 434 to form a first ordered set 506 of entity identifiers 410. The first ordered set 506 of entity identifier 410 is input to the optimization algorithm 428 implementing the objective function 430 of the optimization layer 404. In some embodiments, for example, a ranking model 124 ranks the set of entity identifiers 410, such as in the first ordered set 506 of entity identifiers 410, based on the set of scores 436 and the (optional) set of rules 434 to form a second ordered set 514 of entity identifiers 410. The second ordered set 514 of entity identifier 410 is input to the selector 438 of the optimization layer 404. The selector 438 selects the entity identifier 440 from the set of entity identifiers 410 based on a rank value for the entity identifier.

FIG. 12 illustrates an apparatus 1200. The apparatus 1200 depicts a training device 1202 suitable for training a ML model 1220 for the connection network system 100. The ML model 1220 is an example of the causal model 442 and/or the generative model 444 of the ML architecture 400 described with reference to FIG. 4. Specifically, the training device 1202 trains the ML model 1220 to perform inferencing operations in support of the content delivery application 122, ranking model 124, or recommendation model 126.

As depicted in FIG. 12, the training device 1202 includes a processing circuitry 1204 and a memory unit 1206. The memory unit 1206 may store a set of ML components 1208 to support various AI/ML techniques. The ML components 1208 comprise a data collector 1210, a model trainer 1212, a model evaluator 1214 and a model inferencer 1216.

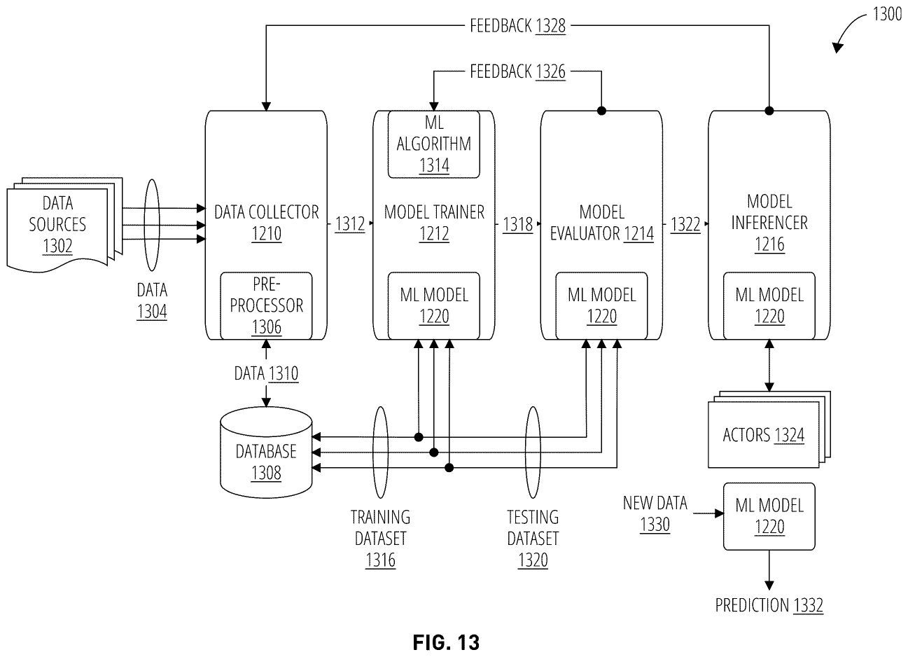

In general, the data collector 1210 collects data 1218 from one or more data sources to use as training data for an ML model 1220. The data collector 1210 collects different types of data 1218, such as text information, audio information, image information, video information, graphic information, and so forth. The model trainer 1212 receives as input the collected data and uses a portion of the collected data as test data for an AI/ML algorithm to train the ML model 1220. The model evaluator 1214 evaluates and improves the trained ML model 1220 using a portion of the collected data as test data to test the ML model 1220. The model evaluator 1214 also uses feedback information from the deployed ML model 1220. The model inferencer 1216 implements the trained ML model 1220 to receive as input new unseen data, generate one or more inferences on the new data, and output a result such as an alert, a recommendation or other post-solution activity. An exemplary AI/ML architecture for the ML components 1208 is described in more detail with reference to FIG. 13.

FIG. 13 illustrates a logic diagram 1300 suitable for use by the training device 1202 to generate the ML model 1220 for deployment by an inferencing device of the connection network platform 112. The logic diagram 1300 is an example of a system suitable for implementing various AI techniques and/or ML techniques to perform various training tasks on behalf of the various devices of the connection network system 100.

In one embodiment, the training device 1202 trains an ML model 1220. In the context of machine learning, “training” refers to the process of teaching a model to recognize patterns and make predictions based on data. This involves initializing the model with initial parameters, which are often set randomly. The model is then provided with a dataset that includes input features and the corresponding correct outputs, often referred to as labels or targets. As the model processes this data, it generates predictions based on its current parameters. The difference between these predictions and the actual target values is measured using a loss function, which quantifies the model's accuracy. The goal is to minimize this loss. To achieve this, the model's parameters are adjusted using optimization techniques such as gradient descent. By continuously refining these parameters, the model gradually improves its predictions. This cycle of making predictions, calculating the loss, and updating parameters is repeated many times, allowing the model to learn and improve over time. The ultimate aim of training is to produce a model that performs well not just on the training data but also on new, unseen data. This ensures the model's ability to generalize, making it effective in real-world applications.

In various embodiments, the training device 1202 may pretrain an ML model 1220 before training the ML model 1220 or trains a pretrained ML model 1220. In the context of machine learning, “pretraining” refers to the initial phase of training a model on a large, general dataset before fine-tuning it on a more specific task or dataset. This approach is particularly common in deep learning, especially with models like neural networks that can benefit from learning basic patterns and representations from broad data before being specialized for a particular application. During pretraining, the model is exposed to a diverse set of data, allowing it to learn fundamental features or representations that are useful across various tasks. For example, in natural language processing, a model might be pretrained on a large corpus of text to understand language structure and grammar. Once the model has acquired this general knowledge, it can be fine-tuned on a smaller, task-specific dataset, such as sentiment analysis or translation. Pretraining is beneficial because it allows the model to start with a good foundation of knowledge, which can lead to better performance and faster convergence during the fine-tuning phase. It also helps when there is limited labeled data for the specific task, as the pretrained model already has a strong understanding from the broader data.

AI is a science and technology based on principles of cognitive science, computer science and other related disciplines, which deals with the creation of intelligent machines that work and react like humans. AI is used to develop systems that can perform tasks that require human intelligence such as recognizing speech, vision and making decisions. AI can be seen as the ability for a machine or computer to think and learn, rather than just following instructions. ML is a subset of AI that uses algorithms to enable machines to learn from existing data and generate insights or predictions from that data. ML algorithms are used to optimize machine performance in various tasks such as classifying, clustering and forecasting. ML algorithms are used to create ML models that can accurately predict outcomes.

In general, the logic diagram 1300 includes various machine or computer components (e.g., circuit, processor circuit, memory, network interfaces, compute platforms, input/output (I/O) devices, etc.) for an AI/ML system that are designed to work together to create a pipeline that can take in raw data, process it, train an ML model 1220, evaluate performance of the trained ML model 1220, and deploy the tested ML model 1220 as the trained ML model 1220 in a production environment, and continuously monitor and maintain it.

The ML model 1220 is a mathematical construct used to predict outcomes based on a set of input data. The ML model 1220 is trained using large volumes of training dataset 1316, and it can recognize patterns and trends in the training dataset 1316 to make accurate predictions. The ML model 1220 is derived from an ML algorithm 1314. A data set is fed into the ML algorithm 1314 which trains an ML model 1220 to “learn” a function that produces mappings between a set of inputs and a set of outputs with a reasonably high accuracy. Given a sufficiently large enough set of inputs and outputs, the ML algorithm 1314 finds the function for a given task. This function may even be able to produce the correct output for input that it has not seen during training. A data scientist prepares the mappings, selects and tunes the ML algorithm 1314, and evaluates the resulting model performance. Once the ML model 1220 is sufficiently accurate on test data, it can be deployed for production use.

The ML algorithm 1314 is generally a computational procedure used to identify patterns within data and make inferences or predictions without being explicitly programmed for every scenario. The ML algorithm 1314 can process input data, learn from it by adjusting internal parameters, and then apply the learned information to new, unseen data. The ML algorithm 1314 may comprise any ML algorithm suitable for a given AI task. Examples of ML algorithms may include supervised algorithms, unsupervised algorithms, or semi-supervised algorithms.

A supervised algorithm is a type of machine learning algorithm that uses labeled data to train a machine learning model. In supervised learning, the machine learning algorithm is given a set of input data and corresponding output data, which are used to train the model to make predictions or classifications. The input data is also known as the features, and the output data is known as the target or label. The goal of a supervised algorithm is to learn the relationship between the input features and the target labels, so that it can make accurate predictions or classifications for new, unseen data. Examples of supervised learning algorithms include: (1) linear regression which is a regression algorithm used to predict continuous numeric values, such as stock prices or temperature; (2) logistic regression which is a classification algorithm used to predict binary outcomes, such as whether a customer will purchase or not purchase a product; (3) decision tree which is a classification algorithm used to predict categorical outcomes by creating a decision tree based on the input features; or (4) random forest which is an ensemble algorithm that combines multiple decision trees to make more accurate predictions.

An unsupervised algorithm is a type of machine learning algorithm that is used to find patterns and relationships in a dataset without the need for labeled data. Unlike supervised learning, where the algorithm is provided with labeled training data and learns to make predictions based on that data, unsupervised learning works with unlabeled data and seeks to identify underlying structures or patterns. Unsupervised learning algorithms use a variety of techniques to discover patterns in the data, such as clustering, anomaly detection, and dimensionality reduction. Clustering algorithms group similar data points together, while anomaly detection algorithms identify unusual or unexpected data points. Dimensionality reduction algorithms are used to reduce the number of features in a dataset, making it easier to analyze and visualize. Unsupervised learning has many applications, such as in data mining, pattern recognition, and recommendation systems. It is particularly useful for tasks where labeled data is scarce or difficult to obtain, and where the goal is to gain insights and understanding from the data itself rather than to make predictions based on it.

Semi-supervised learning is a type of machine learning algorithm that combines both labeled and unlabeled data to improve the accuracy of predictions or classifications. In this approach, the algorithm is trained on a small amount of labeled data and a much larger amount of unlabeled data. The main idea behind semi-supervised learning is that labeled data is often scarce and expensive to obtain, whereas unlabeled data is abundant and easy to collect. By leveraging both types of data, semi-supervised learning can achieve higher accuracy and better generalization than either supervised or unsupervised learning alone. In semi-supervised learning, the algorithm first uses the labeled data to learn the underlying structure of the problem. It then uses this knowledge to identify patterns and relationships in the unlabeled data, and to make predictions or classifications based on these patterns. Semi-supervised learning has many applications, such as in speech recognition, natural language processing, and computer vision. It is particularly useful for tasks where labeled data is expensive or time-consuming to obtain, and where the goal is to improve the accuracy of predictions or classifications by leveraging large amounts of unlabeled data.

The ML algorithm 1314 of the logic diagram 1300 is implemented using various types of ML algorithms including supervised algorithms, unsupervised algorithms, semi-supervised algorithms, or a combination thereof. A few examples of ML algorithms include support vector machine (SVM), random forests, naive Bayes, K-means clustering, neural networks, and so forth. A SVM is an algorithm that can be used for both classification and regression problems. It works by finding an optimal hyperplane that maximizes the margin between the two classes. Random forests is a type of decision tree algorithm that is used to make predictions based on a set of randomly selected features. Naive Bayes is a probabilistic classifier that makes predictions based on the probability of certain events occurring. K-Means Clustering is an unsupervised learning algorithm that groups data points into clusters. Neural networks is a type of machine learning algorithm that is designed to mimic the behavior of neurons in the human brain. Other examples of ML algorithms include a support vector machine (SVM) algorithm, a random forest algorithm, a naive Bayes algorithm, a K-means clustering algorithm, a neural network algorithm, an artificial neural network (ANN) algorithm, a convolutional neural network (CNN) algorithm, a recurrent neural network (RNN) algorithm, a long short-term memory (LSTM) algorithm, a deep learning algorithm, a decision tree learning algorithm, a regression analysis algorithm, a Bayesian network algorithm, a genetic algorithm, a federated learning algorithm, a distributed artificial intelligence algorithm, and so forth. Embodiments are not limited in this context.

As depicted in FIG. 13, the logic diagram 1300 includes a set of data sources 1302 to source data 1304 for the training device 1202. Data sources 1302 may comprise any device capable generating, processing, storing or managing data 1304 suitable for a ML system. Examples of data sources 1302 include without limitation databases, web scraping, sensors and Internet of Things (IoT) devices, image and video cameras, audio devices, text generators, publicly available databases, private databases, and many other data sources 1302. The data sources 1302 may be remote from the training device 1202 and accessed via a network, local to the training device 1202 and accessed via a network interface, or may be a combination of local and remote data sources 1302.

The data sources 1302 source difference types of data 1304. By way of example and not limitation, the data 1304 includes structured data from relational databases, such as customer profiles, transaction histories, or product inventories. The data 1304 includes unstructured data from websites such as customer reviews, news articles, social media posts, or product specifications. The data 1304 includes data from temperature sensors, motion detectors, and smart home appliances. The data 1304 includes image data from medical images, security footage, or satellite images. The data 1304 includes audio data from speech recognition, music recognition, or call centers. The data 1304 includes text data from emails, chat logs, customer feedback, news articles or social media posts. The data 1304 includes publicly available datasets such as those from government agencies, academic institutions, or research organizations. These are just a few examples of the many sources of data that can be used for ML systems. It is important to note that the quality and quantity of the data is critical for the success of a machine learning project.

The data 1304 is typically in different formats such as structured, unstructured or semi-structured data. Structured data refers to data that is organized in a specific format or schema, such as tables or spreadsheets. Structured data has a well-defined set of rules that dictate how the data should be organized and represented, including the data types and relationships between data elements. Unstructured data refers to any data that does not have a predefined or organized format or schema. Unlike structured data, which is organized in a specific way, unstructured data can take various forms, such as text, images, audio, or video. Unstructured data can come from a variety of sources, including social media, emails, sensor data, and website content. Semi-structured data is a type of data that does not fit neatly into the traditional categories of structured and unstructured data. It has some structure but does not conform to the rigid structure of a traditional relational database. Semi-structured data is characterized by the presence of tags or metadata that provide some structure and context for the data.

The data sources 1302 are communicatively coupled to a data collector 1210. The data collector 1210 gathers relevant data 1304 from the data sources 1302, such as the entity data 134 and activity data 136 stored in data store 132 of the connection network system 100, for example. Once collected, the data collector 1210 may use a pre-processor 1306 to make the data 1304 suitable for analysis. This involves data cleaning, transformation, and feature engineering. Data preprocessing is a critical step in ML as it directly impacts the accuracy and effectiveness of the ML model 1220. The pre-processor 1306 receives the data 1304 as input, processes the data 1304, and outputs pre-processed data 1310 for storage in a database 1308. Examples for the database 1308 includes a hard drive, solid state storage, and/or random access memory (RAM).

The data collector 1210 is communicatively coupled to a model trainer 1212. The model trainer 1212 performs AI/ML model training, validation, and testing which may generate model performance metrics as part of the model testing procedure. The model trainer 1212 receives the pre-processed data 1310 as input 1312 or via the database 1308. The model trainer 1212 implements a suitable ML algorithm 1314 to train an ML model 230 on a set of training dataset 1316 from the pre-processed data 1310. The training process involves feeding the pre-processed data 1310 into the ML algorithm 1314 to produce or optimize an ML model 1220. The training process adjusts its parameters until it achieves an initial level of satisfactory performance.

The model trainer 1212 is communicatively coupled to a model evaluator 1214. After an ML model 1220 is trained, the ML model 1220 needs to be evaluated to assess its performance. This is done using various metrics such as accuracy, precision, recall, and F1 score. The model trainer 1212 outputs the ML model 1220, which is received as input 1312 or from the database 1308. The model evaluator 1214 receives the ML model 230 as input 1318, and it initiates an evaluation process to measure performance of the ML model 1220. The evaluation process includes providing feedback 1326 to the model trainer 1212. The model trainer 1212 re-trains the ML model 1220 to improve performance in an iterative manner.

The model evaluator 1214 is communicatively coupled to a model inferencer 1216. The model inferencer 1216 provides AI/ML model inference output (e.g., inferences, predictions or decisions). Once the ML model 1220 is trained and evaluated, it is deployed in a production environment where it is used to make predictions on new data. The model inferencer 1216 receives the evaluated ML model 1220 as input 1322. The model inferencer 1216 uses the evaluated ML model 1220 to produce insights or predictions on real data, which is deployed as a final production ML model 1220. The inference output of the ML model 1220 is use case specific. The model inferencer 1216 also performs model monitoring and maintenance, which involves continuously monitoring performance of the ML model 1220 in the production environment and making any necessary updates or modifications to maintain its accuracy and effectiveness. The model inferencer 1216 provides feedback 1326 to the data collector 1210 to train or re-train the ML model 1220. The feedback 1326 includes model performance feedback information, which is used for monitoring and improving performance of the ML model 1220.

Some or all of the model inferencer 1216 is implemented by various actors 1324 in the logic diagram 1300, including the ML model 1220 of the connection network platform 112, for example. The actors 1324 use the deployed ML model 1220 on new data to make inferences or predictions for a given task, and output a prediction 1332. The actors 1324 implement the model inferencer 1216 locally, or remotely receives outputs from the model inferencer 1216 in a distributed computing manner. The actors 1324 trigger actions directed to other entities or to itself. The actors 1324 provide feedback 1328 to the data collector 1210 via the model inferencer 1216. The feedback 1328 comprise data needed to derive training data, inference data or to monitor the performance of the ML model 1220 and its impact to the network through updating of key performance indicators (KPIs) and performance counters.

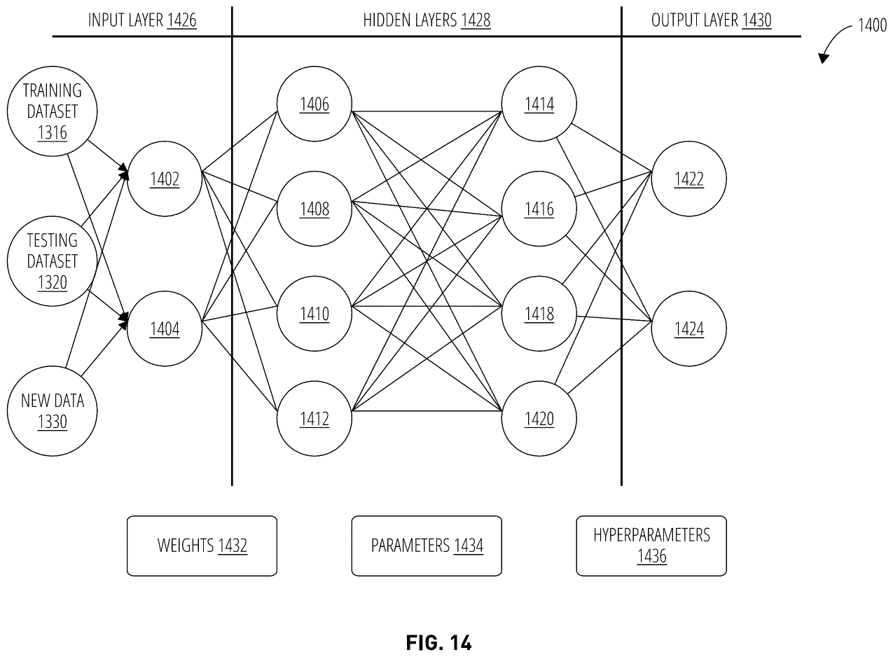

As previously described with reference to FIGS. 1, 2, the connection network system 100 and/or the apparatus 1200 may implement some or all of the logic diagram 1300 to support various use cases and solutions for various AI/ML tasks. In various embodiments, the training device 1202 of the apparatus 1200 uses the logic diagram 1300 to generate and train the ML model 230 for use by the connection network platform 112 for the client application 110. In one embodiment, for example, the training device 1202 may train the ML model 1220 as a neural network, as described in more detail with reference to FIG. 14. Other use cases and solutions for AI/ML are possible as well, and embodiments are not limited in this context.

FIG. 14 illustrates an embodiment of an artificial neural network 1400. Neural networks, also known as artificial neural networks (ANNs) or simulated neural networks (SNNs), are a subset of machine learning and are at the core of deep learning algorithms. Their name and structure are inspired by the human brain, mimicking the way that biological neurons signal to one another.

Artificial neural network 1400 comprises multiple node layers, containing an input layer 1426, one or more hidden layers 1428, and an output layer 1430. Each layer comprises one or more nodes, such as nodes 1402 to 1424. As depicted in FIG. 14, for example, the input layer 1426 has nodes 1402, 1404. The artificial neural network 1400 has two hidden layers 1428, with a first hidden layer having nodes 1406, 1408, 1410 and 1412, and a second hidden layer having nodes 1414, 1416, 1418 and 1420. The artificial neural network 1400 has an output layer 1430 with nodes 1422, 1424. Each node 1402 to 1424 comprises a processing element (PE), or artificial neuron, that connects to another and has an associated weight and threshold. If the output of any individual node is above the specified threshold value, that node is activated, sending data to the next layer of the network. Otherwise, no data is passed along to the next layer of the network.

In general, artificial neural network 1400 relies on training dataset 1316 to learn and improve accuracy over time. However, once the artificial neural network 1400 is fine-tuned for accuracy, and tested on testing dataset 1320, the artificial neural network 1400 is ready to classify and cluster new data 1330 at a high velocity. Tasks in speech recognition or image recognition can take minutes versus hours when compared to the manual identification by human experts.

Each individual node 1402 to 424 is a linear regression model, composed of input data, weights, a bias (or threshold), and an output. The linear regression model may have a formula similar to Equation (4), as follows:

$$\sum wixi + bias = w 1 \times 1 + w 2 \times 2 + w 3 \times 3 + bias \\ output = f ( x ) = 1 if \sum w 1 \times 1 + b >= 0 ; 0 if \sum w 1 \times 1 + b < 0 \qquad EQUATION ( 4 )$$

Once an input layer 1426 is determined, a set of weights 1432 are assigned. The weights 1432 help determine the importance of any given variable, with larger ones contributing more significantly to the output compared to other inputs. All inputs are then multiplied by their respective weights and then summed. Afterward, the output is passed through an activation function, which determines the output. If that output exceeds a given threshold, it “fires” (or activates) the node, passing data to the next layer in the network. This results in the output of one node becoming in the input of the next node. The process of passing data from one layer to the next layer defines the artificial neural network 1400 as a feedforward network.

In one embodiment, the artificial neural network 1400 leverages sigmoid neurons, which are distinguished by having values between 0 and 1. Since the artificial neural network 1400 behaves similarly to a decision tree, cascading data from one node to another, having x values between 0 and 1 will reduce the impact of any given change of a single variable on the output of any given node, and subsequently, the output of the artificial neural network 1400.

The artificial neural network 1400 has many practical use cases, like image recognition, speech recognition, text recognition or classification. The artificial neural network 1400 leverages supervised learning, or labeled datasets, to train the algorithm. As the model is trained, its accuracy is measured using a cost (or loss) function. This is also commonly referred to as the mean squared error (MSE). An example of a cost function is shown in Equation (2), as follows:

$$Cost function = MSE = \frac{1}{2 m} {\sum }_{i = 1}^{m} {( {\hat{y}}_{i} - {y}_{i} )}^{2} \to MIN \qquad EQUATION ( 5 )$$

Where i represents the index of the sample, y-hat is the predicted outcome, y is the actual value, and m is the number of samples.

Ultimately, the goal is to minimize the cost function to ensure correctness of fit for any given observation. As the model adjusts its weights and bias, it uses the cost function and reinforcement learning to reach the point of convergence, or the local minimum. The process in which the algorithm adjusts its weights is through gradient descent, allowing the model to determine the direction to take to reduce errors (or minimize the cost function). With each training example, the parameters 1434 of the model adjust to gradually converge at the minimum.

In one embodiment, the artificial neural network 1400 is feedforward, meaning it flows in one direction only, from input to output. In one embodiment, the artificial neural network 1400 uses backpropagation. Backpropagation is when the artificial neural network 1400 moves in the opposite direction from output to input. Backpropagation allows calculation and attribution of errors associated with each neuron 1402 to 1424, thereby allowing adjustment to fit the parameters 1434 of the ML model 230 appropriately.

The artificial neural network 1400 is implemented as different neural networks depending on a given task. Neural networks are classified into different types, which are used for different purposes. In one embodiment, the artificial neural network 1400 is implemented as a feedforward neural network, or multi-layer perceptrons (MLPs), comprised of an input layer 1426, hidden layers 1428, and an output layer 1430. While these neural networks are also commonly referred to as MLPs, they are actually comprised of sigmoid neurons, not perceptrons, as most real-world problems are nonlinear. Trained data 1304 usually is fed into these models to train them, and they are the foundation for computer vision, natural language processing, and other neural networks. In one embodiment, the artificial neural network 1400 is implemented as a convolutional neural network (CNN). A CNN is similar to feedforward networks, but usually utilized for image recognition, pattern recognition, and/or computer vision. These networks harness principles from linear algebra, particularly matrix multiplication, to identify patterns within an image. In one embodiment, the artificial neural network 1400 is implemented as a recurrent neural network (RNN). A RNN is identified by feedback loops. The RNN learning algorithms are primarily leveraged when using time-series data to make predictions about future outcomes, such as stock market predictions or sales forecasting. The artificial neural network 1400 is implemented as any type of neural network suitable for a given operational task of system 200, and the MLP, CNN, and RNN are merely a few examples. Embodiments are not limited in this context.

The artificial neural network 1400 includes a set of associated parameters 1434. There are a number of different parameters that must be decided upon when designing a neural network. Among these parameters are the number of layers, the number of neurons per layer, the number of training iterations, and so forth. Some of the more important parameters in terms of training and network capacity are a number of hidden neurons parameter, a learning rate parameter, a momentum parameter, a training type parameter, an Epoch parameter, a minimum error parameter, and so forth.

In some cases, the artificial neural network 1400 is implemented as a deep learning neural network. The term deep learning neural network refers to a depth of layers in a given neural network. A neural network that has more than three layers—which would be inclusive of the inputs and the output—can be considered a deep learning algorithm. A neural network that only has two or three layers, however, may be referred to as a basic neural network. A deep learning neural network may tune and optimize one or more hyperparameters 1436. A hyperparameter is a parameter whose values are set before starting the model training process. Deep learning models, including convolutional neural network (CNN) and recurrent neural network (RNN) models can have anywhere from a few hyperparameters to a few hundred hyperparameters. The values specified for these hyperparameters impacts the model learning rate and other regulations during the training process as well as final model performance. A deep learning neural network uses hyperparameter optimization algorithms to automatically optimize models. The algorithms used include Random Search, Tree-structured Parzen Estimator (TPE) and Bayesian optimization based on the Gaussian process. These algorithms are combined with a distributed training engine for quick parallel searching of the optimal hyperparameter values.

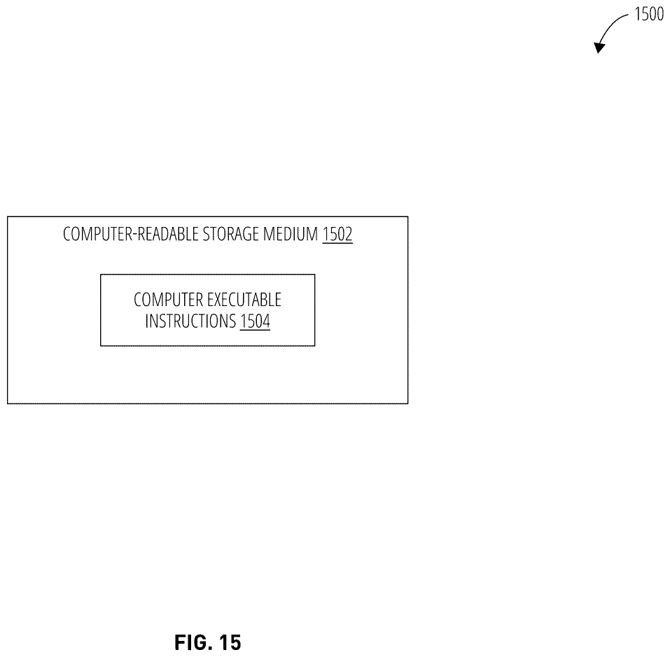

FIG. 15 illustrates an apparatus 1500. Apparatus 1500 comprises any non-transitory computer-readable storage medium 1502 or machine-readable storage medium, such as an optical, magnetic or semiconductor storage medium. In various embodiments, apparatus 1500 comprises an article of manufacture or a product. In some embodiments, the computer-readable storage medium 1502 stores computer executable instructions with which one or more processing devices or processing circuitry can execute. For example, computer executable instructions 1504 includes instructions to implement operations described with respect to any logic flows described herein. Examples of computer-readable storage medium 1502 or machine-readable storage medium include any tangible media capable of storing electronic data, including volatile memory or non-volatile memory, removable or non-removable memory, erasable or non-erasable memory, writeable or re-writeable memory, and so forth. Examples of computer executable instructions 1504 include any suitable type of code, such as source code, compiled code, interpreted code, executable code, static code, dynamic code, object-oriented code, visual code, and the like.

FIG. 16 illustrates an embodiment of a computing architecture 1600. Computing architecture 1600 is a computer system with multiple processor cores such as a distributed computing system, supercomputer, high-performance computing system, computing cluster, mainframe computer, mini-computer, client-server system, personal computer (PC), workstation, server, portable computer, laptop computer, tablet computer, handheld device such as a personal digital assistant (PDA), or other device for processing, displaying, or transmitting information. Similar embodiments may comprise, e.g., entertainment devices such as a portable music player or a portable video player, a smart phone or other cellular phone, a telephone, a digital video camera, a digital still camera, an external storage device, or the like. Further embodiments implement larger scale server configurations. In other embodiments, the computing architecture 1600 has a single processor with one core or more than one processor. Note that the term “processor” refers to a processor with a single core or a processor package with multiple processor cores. In at least one embodiment, the computing architecture 1600 is representative of the components of the system 200. More generally, the computing architecture 1600 is configured to implement all logic, systems, logic flows, methods, apparatuses, and functionality described herein with reference to previous figures.

As used in this application, the terms “system” and “component” and “module” are intended to refer to a computer-related entity, either hardware, a combination of hardware and software, software, or software in execution, examples of which are provided by the exemplary computing architecture 1600. For example, a component is, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server are a component. One or more components reside within a process and/or thread of execution, and a component is localized on one computer and/or distributed between two or more computers. Further, components are communicatively coupled to each other by various types of communications media to coordinate operations. The coordination involves the uni-directional or bi-directional exchange of information. For instance, the components communicate information in the form of signals communicated over the communications media. The information is implemented as signals allocated to various signal lines. In such allocations, each message is a signal. Further embodiments, however, alternatively employ data messages. Such data messages may be sent across various connections. Exemplary connections include parallel interfaces, serial interfaces, and bus interfaces.

As shown in FIG. 16, computing architecture 1600 comprises a system-on-chip (SoC) 1602 for mounting platform components. System-on-chip (SoC) 1602 is a point-to-point (P2P) interconnect platform that includes a first processor 1604 and a second processor 1606 coupled via a point-to-point interconnect 1670 such as an Ultra Path Interconnect (UPI). In other embodiments, the computing architecture 1600 is another bus architecture, such as a multi-drop bus. Furthermore, each of processor 1604 and processor 1606 are processor packages with multiple processor cores including core(s) 1608 and core(s) 1610, respectively. While the computing architecture 1600 is an example of a two-socket (2S) platform, other embodiments include more than two sockets or one socket. For example, some embodiments include a four-socket (4S) platform or an eight-socket (8S) platform. Each socket is a mount for a processor and may have a socket identifier. Note that the term platform refers to a motherboard with certain components mounted such as the processor 1604 and chipset 1632. Some platforms include additional components and some platforms include sockets to mount the processors and/or the chipset. Furthermore, some platforms do not have sockets (e.g. SoC, or the like). Although depicted as a SoC 1602, one or more of the components of the SoC 1602 are included in a single die package, a multi-chip module (MCM), a multi-die package, a chiplet, a bridge, and/or an interposer. Therefore, embodiments are not limited to a SoC.

The processor 1604 and processor 1606 are any commercially available processors, including without limitation an Intel® Celeron®, Core®, Core (2) Duo®, Itanium®, Pentium® Xeon®, and XScale® processors; AMD® Athlon®, Duron® and Opteron® processors; ARM® application, embedded and secure processors; IBM® and Motorola® DragonBall® and PowerPC® processors; IBM and Sony® Cell processors; and similar processors. Dual microprocessors, multi-core processors, and other multi-processor architectures are also employed as the processor 1604 and/or processor 1606. Additionally, the processor 1604 need not be identical to processor 1606.

Processor 1604 includes an integrated memory controller (IMC) 1620 and point-to-point (P2P) interface 1624 and P2P interface 1628. Similarly, the processor 1606 includes an IMC 1622 as well as P2P interface 1626 and P2P interface 1630. IMC 1620 and IMC 1622 couple the processor 1604 and processor 1606, respectively, to respective memories (e.g., memory 1616 and memory 1618). Memory 1616 and memory 1618 are portions of the main memory (e.g., a dynamic random-access memory (DRAM)) for the platform such as double data rate type 4 (DDR4) or type 5 (DDR5) synchronous DRAM (SDRAM). In the present embodiment, the memory 1616 and the memory 1618 locally attach to the respective processors (i.e., processor 1604 and processor 1606). In other embodiments, the main memory couple with the processors via a bus and shared memory hub. Processor 1604 includes registers 1612 and processor 1606 includes registers 1614.

Computing architecture 1600 includes chipset 1632 coupled to processor 1604 and processor 1606. Furthermore, chipset 1632 are coupled to storage device 1650, for example, via an interface (I/F) 1638. The I/F 1638 may be, for example, a Peripheral Component Interconnect-enhanced (PCIe) interface, a Compute Express Link® (CXL) interface, or a Universal Chiplet Interconnect Express (UCIe) interface. Storage device 1650 stores instructions executable by circuitry of computing architecture 1600 (e.g., processor 1604, processor 1606, GPU 1648, accelerator 1654, vision processing unit 1656, or the like). For example, storage device 1650 can store instructions for the client device 202, the client device 206, the inferencing device 204, the training device 1202, or the like.

Processor 1604 couples to the chipset 1632 via P2P interface 1628 and P2P 1634 while processor 1606 couples to the chipset 1632 via P2P interface 1630 and P2P 1636. Direct media interface (DMI) 1676 and DMI 1678 couple the P2P interface 1628 and the P2P 1634 and the P2P interface 1630 and P2P 1636, respectively. DMI 1676 and DMI 1678 is a high-speed interconnect that facilitates, e.g., eight Giga Transfers per second (GT/s) such as DMI 3.0. In other embodiments, the processor 1604 and processor 1606 interconnect via a bus.

The chipset 1632 comprises a controller hub such as a platform controller hub (PCH). The chipset 1632 includes a system clock to perform clocking functions and include interfaces for an I/O bus such as a universal serial bus (USB), peripheral component interconnects (PCIs), CXL interconnects, UCIe interconnects, interface serial peripheral interconnects (SPIs), integrated interconnects (I2Cs), and the like, to facilitate connection of peripheral devices on the platform. In other embodiments, the chipset 1632 comprises more than one controller hub such as a chipset with a memory controller hub, a graphics controller hub, and an input/output (I/O) controller hub.

In the depicted example, chipset 1632 couples with a trusted platform module (TPM) 1644 and UEFI, BIOS, FLASH circuitry 1646 via I/F 1642. The TPM 1644 is a dedicated microcontroller designed to secure hardware by integrating cryptographic keys into devices. The UEFI, BIOS, FLASH circuitry 1646 may provide pre-boot code. The I/F 1642 may also be coupled to a network interface circuit (NIC) 1680 for connections off-chip.

Furthermore, chipset 1632 includes the I/F 1638 to couple chipset 1632 with a high-performance graphics engine, such as, graphics processing circuitry or a graphics processing unit (GPU) 1648. In other embodiments, the computing architecture 1600 includes a flexible display interface (FDI) (not shown) between the processor 1604 and/or the processor 1606 and the chipset 1632. The FDI interconnects a graphics processor core in one or more of processor 1604 and/or processor 1606 with the chipset 1632.

The computing architecture 1600 is operable to communicate with wired and wireless devices or entities via the network interface (NIC) 180 using the IEEE 802 family of standards, such as wireless devices operatively disposed in wireless communication (e.g., IEEE 802.11 over-the-air modulation techniques). This includes at least Wi-Fi (or Wireless Fidelity), WiMax, and Bluetooth™ wireless technologies, 3G, 4G, LTE wireless technologies, among others. Thus, the communication is a predefined structure as with a conventional network or simply an ad hoc communication between at least two devices. Wi-Fi networks use radio technologies called IEEE 802.11x (a, b, g, n, ac, ax, etc.) to provide secure, reliable, fast wireless connectivity. A Wi-Fi network is used to connect computers to each other, to the Internet, and to wired networks (which use IEEE 802.3-related media and functions).

Additionally, accelerator 1654 and/or vision processing unit 1656 are coupled to chipset 1632 via I/F 1638. The accelerator 1654 is representative of any type of accelerator device (e.g., a data streaming accelerator, cryptographic accelerator, cryptographic co-processor, an offload engine, etc.). One example of an accelerator 1654 is the Intel® Data Streaming Accelerator (DSA). The accelerator 1654 is a device including circuitry to accelerate copy operations, data encryption, hash value computation, data comparison operations (including comparison of data in memory 1616 and/or memory 1618), and/or data compression. Examples for the accelerator 1654 include a USB device, PCI device, PCIe device, CXL device, UCIe device, and/or an SPI device. The accelerator 1654 also includes circuitry arranged to execute machine learning (ML) related operations (e.g., training, inference, etc.) for ML models. Generally, the accelerator 1654 is specially designed to perform computationally intensive operations, such as hash value computations, comparison operations, cryptographic operations, and/or compression operations, in a manner that is more efficient than when performed by the processor 1604 or processor 1606. Because the load of the computing architecture 1600 includes hash value computations, comparison operations, cryptographic operations, and/or compression operations, the accelerator 1654 greatly increases performance of the computing architecture 1600 for these operations.

The accelerator 1654 includes one or more dedicated work queues and one or more shared work queues (each not pictured). Generally, a shared work queue is configured to store descriptors submitted by multiple software entities. The software is any type of executable code, such as a process, a thread, an application, a virtual machine, a container, a microservice, etc., that share the accelerator 1654. For example, the accelerator 1654 is shared according to the Single Root I/O virtualization (SR-IOV) architecture and/or the Scalable I/O virtualization (S-IOV) architecture. Embodiments are not limited in these contexts. In some embodiments, software uses an instruction to atomically submit the descriptor to the accelerator 1654 via a non-posted write (e.g., a deferred memory write (DMWr)). One example of an instruction that atomically submits a work descriptor to the shared work queue of the accelerator 1654 is the ENQCMD command or instruction (which may be referred to as “ENQCMD” herein) supported by the Intel® Instruction Set Architecture (ISA). However, any instruction having a descriptor that includes indications of the operation to be performed, a source virtual address for the descriptor, a destination virtual address for a device-specific register of the shared work queue, virtual addresses of parameters, a virtual address of a completion record, and an identifier of an address space of the submitting process is representative of an instruction that atomically submits a work descriptor to the shared work queue of the accelerator 1654. The dedicated work queue may accept job submissions via commands such as the movdir64b instruction.

Various I/O devices 1660 and display 1652 couple to the bus 1672, along with a bus bridge 1658 which couples the bus 1672 to a second bus 1674 and an I/F 1640 that connects the bus 1672 with the chipset 1632. In one embodiment, the second bus 1674 is a low pin count (LPC) bus. Various input/output (I/O) devices couple to the second bus 1674 including, for example, a keyboard 1662, a mouse 1664 and communication devices 1666.

Furthermore, an audio I/O 1668 couples to second bus 1674. Many of the I/O devices 1660 and communication devices 1666 reside on the system-on-chip (SoC) 1602 while the keyboard 1662 and the mouse 1664 are add-on peripherals. In other embodiments, some or all the I/O devices 1660 and communication devices 1666 are add-on peripherals and do not reside on the system-on-chip (SoC) 1602.

FIG. 17 illustrates a block diagram of an exemplary communications architecture 1700 suitable for implementing various embodiments as previously described. The communications architecture 1700 includes various common communications elements, such as a transmitter, receiver, transceiver, radio, network interface, baseband processor, antenna, amplifiers, filters, power supplies, and so forth. The embodiments, however, are not limited to implementation by the communications architecture 1700.

As shown in FIG. 17, the communications architecture 1700 includes one or more clients 1702 and servers 1704. The clients 1702 and the servers 1704 are operatively connected to one or more respective client data stores 1708 and server data stores 1710 that can be employed to store information local to the respective clients 1702 and servers 1704, such as cookies and/or associated contextual information.

The clients 1702 and the servers 1704 communicate information between each other using a communication framework 1706. The communication framework 1706 implements any well-known communications techniques and protocols. The communication framework 1706 is implemented as a packet-switched network (e.g., public networks such as the Internet, private networks such as an enterprise intranet, and so forth), a circuit-switched network (e.g., the public switched telephone network), or a combination of a packet-switched network and a circuit-switched network (with suitable gateways and translators).

The communication framework 1706 implements various network interfaces arranged to accept, communicate, and connect to a communications network. A network interface is regarded as a specialized form of an input output interface. Network interfaces employ connection protocols including without limitation direct connect, Ethernet (e.g., thick, thin, twisted pair 10/200/1000 Base T, and the like), token ring, wireless network interfaces, cellular network interfaces, IEEE 802.11 network interfaces, IEEE 802.16 network interfaces, IEEE 802.20 network interfaces, and the like. Further, multiple network interfaces are used to engage with various communications network types. For example, multiple network interfaces are employed to allow for the communication over broadcast, multicast, and unicast networks. Should processing requirements dictate a greater amount speed and capacity, distributed network controller architectures are similarly employed to pool, load balance, and otherwise increase the communicative bandwidth required by clients 1702 and the servers 1704. A communications network is any one and the combination of wired and/or wireless networks including without limitation a direct interconnection, a secured custom connection, a private network (e.g., an enterprise intranet), a public network (e.g., the Internet), a Personal Area Network (PAN), a Local Area Network (LAN), a Metropolitan Area Network (MAN), an Operating Missions as Nodes on the Internet (OMNI), a Wide Area Network (WAN), a wireless network, a cellular network, and other communications networks.

The various elements of the devices as previously described with reference to the figures include various hardware elements, software elements, or a combination of both. Examples of hardware elements include devices, logic devices, components, processors, microprocessors, circuits, processors, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements varies in accordance with any number of factors, such as desired computational rate, power levels, heat tolerances, processing cycle budget, input data rates, output data rates, memory resources, data bus speeds and other design or performance constraints, as desired for a given implementation.

One or more aspects of at least one embodiment are implemented by representative instructions stored on a machine-readable medium which represents various logic within the processor, which when read by a machine causes the machine to fabricate logic to perform the techniques described herein. Such representations, known as “intellectual property (IP) cores” are stored on a tangible, machine readable medium and supplied to various customers or manufacturing facilities to load into the fabrication machines that make the logic or processor. Some embodiments are implemented, for example, using a machine-readable medium or article which may store an instruction or a set of instructions that, when executed by a machine, causes the machine to perform a method and/or operations in accordance with the embodiments. Such a machine includes, for example, any suitable processing platform, computing platform, computing device, processing device, computing system, processing system, processing devices, computer, processor, or the like, and is implemented using any suitable combination of hardware and/or software. The machine-readable medium or article includes, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions include any suitable type of code, such as source code, compiled code, interpreted code, executable code, static code, dynamic code, encrypted code, and the like, implemented using any suitable high-level, low-level, object-oriented, visual, compiled and/or interpreted programming language.

As utilized herein, terms “component,” “system,” “interface,” and the like are intended to refer to a computer-related entity, hardware, software (e.g., in execution), and/or firmware. For example, a component is a processor (e.g., a microprocessor, a controller, or other processing device), a process running on a processor, a controller, an object, an executable, a program, a storage device, a computer, a tablet PC and/or a user equipment (e.g., mobile phone, etc.) with a processing device. By way of illustration, an application running on a server and the server is also a component. One or more components reside within a process, and a component is localized on one computer and/or distributed between two or more computers. A set of elements or a set of other components are described herein, in which the term “set” can be interpreted as “one or more.”

Further, these components execute from various computer readable storage media having various data structures stored thereon such as with a module, for example. The components communicate via local and/or remote processes such as in accordance with a signal having one or more data packets (e.g., data from one component interacting with another component in a local system, distributed system, and/or across a network, such as, the Internet, a local area network, a wide area network, or similar network with other systems via the signal).

As another example, a component is an apparatus with specific functionality provided by mechanical parts operated by electric or electronic circuitry, in which the electric or electronic circuitry is operated by a software application or a firmware application executed by one or more processors. The one or more processors are internal or external to the apparatus and execute at least a part of the software or firmware application. As yet another example, a component is an apparatus that provides specific functionality through electronic components without mechanical parts; the electronic components include one or more processors therein to execute software and/or firmware that confer(s), at least in part, the functionality of the electronic components.

Use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, to the extent that the terms “including”, “includes”, “having”, “has”, “with”, or variants thereof are used in either the detailed description or the claims, such terms are intended to be inclusive in a manner similar to the term “comprising.” Additionally, in situations wherein one or more numbered items are discussed (e.g., a “first X”, a “second X”, etc.), in general the one or more numbered items may be distinct or they may be the same, although in some situations the context may indicate that they are distinct or that they are the same.

As used herein, the term “circuitry” may refer to, be part of, or include a circuit, an integrated circuit (IC), a monolithic IC, a discrete circuit, a hybrid integrated circuit (HIC), an Application Specific Integrated Circuit (ASIC), an electronic circuit, a logic circuit, a microcircuit, a hybrid circuit, a microchip, a chip, a chiplet, a chipset, a multi-chip module (MCM), a semiconductor die, a system on a chip (SoC), a processor (shared, dedicated, or group), a processor circuit, a processing circuit, or associated memory (shared, dedicated, or group) operably coupled to the circuitry that execute one or more software or firmware programs, a combinational logic circuit, or other suitable hardware components that provide the described functionality. In some embodiments, the circuitry is implemented in, or functions associated with the circuitry are implemented by, one or more software or firmware modules. In some embodiments, circuitry includes logic, at least partially operable in hardware. It is noted that hardware, firmware and/or software elements may be collectively or individually referred to herein as “logic” or “circuit.”

Some embodiments are described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Moreover, unless otherwise noted the features described above are recognized to be usable together in any combination. Thus, any features discussed separately can be employed in combination with each other unless it is noted that the features are incompatible with each other.

Some embodiments are presented in terms of program procedures executed on a computer or network of computers. A procedure is here, and generally, conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, the manipulations performed are often referred to in terms, such as adding or comparing, which are commonly associated with mental operations performed by a human operator. No such capability of a human operator is necessary, or desirable in most cases, in any of the operations described herein, which form part of one or more embodiments. Rather, the operations are machine operations. Useful machines for performing operations of various embodiments include general purpose digital computers or similar devices.

Some embodiments are described using the expression “coupled” and “connected” along with their derivatives. These terms are not necessarily intended as synonyms for each other. For example, some embodiments are described using the terms “connected” and/or “coupled” to indicate that two or more elements are in direct physical or electrical contact with each other. The term “coupled,” however, also means that two or more elements are not in direct contact with each other, but yet still co-operate or interact with each other.

Various embodiments also relate to apparatus or systems for performing these operations. This apparatus is specially constructed for the required purpose or it comprises a general purpose computer as selectively activated or reconfigured by a computer program stored in the computer. The procedures presented herein are not inherently related to a particular computer or other apparatus. Various general purpose machines are used with programs written in accordance with the teachings herein, or it proves convenient to construct more specialized apparatus to perform the required method steps. The required structure for a variety of these machines are apparent from the description given.

It is emphasized that the Abstract of the Disclosure is provided to allow a reader to quickly ascertain the nature of the technical disclosure. It is submitted with the understanding that it will not be used to interpret or limit the scope or meaning of the claims. In addition, the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

The techniques described herein may be implemented with privacy safeguards to protect user privacy. Furthermore, the techniques described herein may be implemented with user privacy safeguards to prevent unauthorized access to personal data and confidential data. The training of the AI models described herein is executed to benefit all users fairly, without causing or amplifying unfair bias.

According to some embodiments, the techniques for the models described herein do not make inferences or predictions about individuals unless requested to do so through an input. According to some embodiments, the models described herein do not learn from and are not trained on entity data without user authorization. In instances where entity data is permitted and authorized for use in AI features and tools, it is done in compliance with a user's visibility settings, privacy choices, user agreement and descriptions, and the applicable law. According to the techniques described herein, users may have full control over the visibility of their content and who sees their content, as is controlled via the visibility settings. According to the techniques described herein, users may have full control over the level of their personal data that is shared and distributed between different AI platforms that provide different functionalities. According to the techniques described herein, users may choose to share personal data with different platforms to provide services that are more tailored to the users. In instances where the users choose not to share personal data with the platforms, the choices made by the users will not have any impact on their ability to use the services that they had access to prior to making their choice.

According to the techniques described herein, users may have full control over the level of access to their personal data that is shared with other parties. According to the techniques described herein, personal data provided by users may be processed to determine prompts when using a generative AI feature at the request of the user, but not to train generative AI models. In some embodiments, users may provide feedback while using the techniques described herein, which may be used to improve or modify the platform and products. In some embodiments, any personal data associated with a user, such as personal information provided by the user to the platform, may be deleted from storage upon user request. In some embodiments, personal information associated with a user may be permanently deleted from storage when a user deletes their account from the platform.

According to the techniques described herein, personal data may be removed from any training dataset that is used to train AI models. The techniques described herein may utilize tools for anonymizing member and customer data. For example, user's personal data may be redacted and minimized in training datasets for training AI models through delexicalisation tools and other privacy enhancing tools for safeguarding entity data. The techniques described herein may minimize use of any personal data in training AI models, including removing and replacing personal data. According to the techniques described herein, notices may be communicated to users to inform how their data is being used and users are provided controls to opt-out from their data being used for training AI models.

According to some embodiments, tools are used with the techniques described herein to identify and mitigate risks associated with AI in all products and AI systems. In some embodiments, notices may be provided to users when AI tools are being used to provide features.

1. A method, comprising:
receiving an input vector comprising a first vector and a second vector by a causal model of a prediction layer of a connection network system, the first vector comprising entity features associated with a set of entity identifiers and the second vector comprising objective features associated with an objective for the set of entity identifiers;
generating an output vector comprising a metric by the causal model based on the first vector and the second vector, the metric comprising a value representing the objective for the set of entity identifiers;
generating a set of scores for the set of entity identifiers using an objective function of an optimization layer, wherein the optimization layer executes an optimization algorithm to generate the set of scores, wherein the optimization algorithm normalizes raw data from the objective function to normalize values for a metric, and wherein the optimization algorithm generates the set of scores based on the metric;
selecting an entity identifier from the set of entity identifiers based on the set of scores;
generating, using an explainability layer, a recommendation for the entity identifier, wherein the explainability layer includes a generative artificial intelligence (GAI) model configured to process an input prompt that includes entity data or activity data associated with the entity identifier to generate the recommendation; and
routing the recommendation to a target application of an electronic device.

2. The method of claim 1, comprising ranking the set of entity identifiers based on the metric to form a first ordered set of entity identifiers prior to generation of the set of scores, wherein the optimization algorithm comprises a mixed integer programming algorithm to implement the objective function.

3. The method of claim 1, comprising ranking the set of entity identifiers based on the scores to form a second ordered set of entity identifiers prior to selection of the entity identifier from the set of entity identifiers.

4. The method of claim 1, comprising:
ranking the set of entity identifiers based on the scores; and
selecting the entity identifier from the set of entity identifiers based on a rank value for the entity identifier.

5. The method of claim 1, comprising normalizing the value for the metric to form a normalized value within a defined range of values.

6. The method of claim 1, comprising:
receiving a set of rules associated with the objective; and
generating the set of scores for the set of entity identifiers based on the metric and the set of rules.

7. The method of claim 1, wherein the GAI model is configured to generate the recommendation using a template.

8. The method of claim 1, comprising:
causing presentation of the recommendation in a graphic user interface (GUI) of the electronic device;
receiving an activation signal from a GUI element of the GUI, the activation signal representing implicit feedback or explicit feedback for the recommendation; and
updating the first vector or the second vector of the input vector based on the activation signal.

9. (canceled)

10. A computing apparatus comprising:
circuitry; and
a memory storing instructions that, when executed by the circuitry, causes the circuitry to:
receive an input vector comprising a first vector and a second vector by a causal model of a prediction layer of a connection network system, the first vector comprising entity features associated with a set of entity identifiers and the second vector comprising objective features associated with an objective for the set of entity identifiers;
generate an output vector comprising a metric by the causal model based on the first vector and the second vector, the metric comprising a value representing the objective for the set of entity identifiers;
generate a set of scores for the set of entity identifiers using an objective function of an optimization layer, wherein the optimization layer executes an optimization algorithm to generate the set of scores, wherein the optimization algorithm normalizes raw data from the objective function to normalize values for a metric, and wherein the optimization algorithm generates the set of scores based on the metric;
select an entity identifier from the set of entity identifiers based on the set of scores;
generate, using an explainability layer, a recommendation for the entity identifier, wherein the explainability layer includes a generative artificial intelligence (GAI) model configured to process an input prompt that includes entity data or activity data associated with the entity identifier to generate the recommendation; and
route the recommendation to a target application of an electronic device.

11. The computing apparatus of claim 10, the circuitry to:
rank the set of entity identifiers based on the scores; and
select the entity identifier from the set of entity identifiers based on a rank value for the entity identifier, wherein the optimization algorithm comprises a mixed integer programming algorithm to implement the objective function.

12. The computing apparatus of claim 10, the circuitry to normalize the value for the metric to form a normalized value within a defined range of values.

13. The computing apparatus of claim 10, the circuitry to:
receive a set of rules associated with the objective; and
generate the set of scores for the set of entity identifiers based on the metric and the set of rules.

14. The computing apparatus of claim 10, wherein the GAI model is configured to generate the recommendation using a template.

15. The computing apparatus of claim 10, the circuitry to:
cause presentation of the recommendation in a graphic user interface (GUI) of the electronic device;
receive an activation signal from a GUI element of the GUI, the activation signal representing implicit feedback or explicit feedback for the recommendation; and
update the first vector or the second vector of the input vector based on the activation signal.

16. (canceled)

17. The computing apparatus of claim 10, the circuitry to:
select a communication modality from a plurality of communication modalities of a unified communications application based on presence information; and
route the recommendation to the target application using the selected communication modality.

18. The computing apparatus of claim 10, the circuitry to analyze the recommendation for violations of a trust policy prior to routing the recommendation to the target application.

19. A non-transitory computer-readable storage medium, the computer-readable storage medium including instructions that when executed by circuitry, cause the circuitry to:
receive an input vector comprising a first vector and a second vector by a causal model of a prediction layer of a connection network system, the first vector comprising entity features associated with a set of entity identifiers and the second vector comprising objective features associated with an objective for the set of entity identifiers;
generate an output vector comprising a metric by the causal model based on the first vector and the second vector, the metric comprising a value representing the objective for the set of entity identifiers;
generate a set of scores for the set of entity identifiers using an objective function of an optimization layer, wherein the optimization layer executes an optimization algorithm to generate the set of scores, wherein the optimization algorithm normalizes raw data from the objective function to normalize values for a metric, and wherein the optimization algorithm generates the set of scores based on the metric;
select an entity identifier from the set of entity identifiers based on the set of scores;
generate, using an explainability layer, a recommendation for the entity identifier, wherein the explainability layer includes a generative artificial intelligence (GAI) model configured to process an input prompt that includes entity data or activity data associated with the entity identifier to generate the recommendation; and
rout the recommendation to a target application of an electronic device.

20. The computer-readable storage medium of claim 19, comprising instructions that when executed by the circuitry, cause the circuitry to:
cause presentation of the recommendation in a graphic user interface (GUI) of the electronic device;
receive an activation signal from a GUI element of the GUI, the activation signal representing implicit feedback or explicit feedback for the recommendation; and
update the first vector or the second vector of the input vector based on the activation signal, wherein the optimization algorithm comprises a mixed integer programming algorithm to implement the objective function.

21. The computer-readable storage medium of claim 19, wherein the GAI model is configured to generate the recommendation using a template.
